(19) United States
(12) Patent Application Publication
(10) Pub. No.: US 2004/0031052 A1
(43) Pub. Date: Feb. 12, 2004

(54) Information platform

(75) Inventors: Jeffrey Ronald Wannamaker, London (CA); Peter Scheyen, London (CA); Allan Lodberg, London (CA); Antoine Boucher, London (CA)

Correspondence Address: MOSER, PATTERSON & SHERIDAN L.L.P., 595 SHREWSBURY AVE, FIRST FLOOR, SHREWSBURY, NJ, 07702, US

(73) Assignee: Liberate Technologies, San Carlos, CA

(21) Appl. No.: 10/218,337

(22) Filed: Aug. 12, 2002

(51) Int. Cl. H04N 5/445; G06F 3/00; G06F 13/00; H04N 7/173

(52) U.S. Cl. 725/61; 725/131; 725/52

(57) ABSTRACT

An inventive client/server system provides a platform for cable system operators to deliver a full range of sophisticated new products to cable television subscribers. Preferably a middleware solution, the information platform provides a flexible, versatile, and adaptable Internet-centric platform that network operators can use to deploy interactive television applications. The information platform mediates the communication between an abundance of Web-based content and the television set. Content and applications are written entirely in industry standard HTML and Java. Traditional television programming is integrated with Web content using TV-specific extensions to HTML and Java. Applications can be loaded from the network, from carousels, or from file systems, such as flash memory or EEPROM. The information platform consists of client-side middleware integrated with a native electronic program guide application. It includes a master application that defines service functionality, TV ticker, a suite of games, and a microbrowser for broadcast managed content. The presently preferred embodiment of the information platform supports broadcast-only applications, i.e. applications not requiring a return path) and also provides limited support for two-way applications such as store and forward and imprint server for gathering subscriber interactions and statistics.

### BACKGROUND OF THE INVENTION

1. Technical Field

The invention relates to information services, such as cable and satellite television services. More particularly, the invention relates to a platform for delivering information, such as television.

2. Description of the Prior Art

Interactive television offers cable television network operators the potential for increased revenue and reduced churn, but imposes the risk of long delays before return on investment is realized. Therefore, it is desirable to use existing, installed equipment to deliver new services and functions.

While various approaches to interactive television are known, recent efforts concern the provision of services to subscribers from a head end in which inherent functionality of a subscriber set-top box is exploited. For example, Gordon, et al., Method and apparatus for providing a menu structure for an interactive information distribution system, U.S. Pat. No. 6,208,335 (Mar. 27, 2001) disclose a “method and apparatus for providing an interactive menu structure within an interactive information distribution system. The menu structure is embodied in a combination of software, which provides a so-called navigator and a set top terminal that provides certain functionality for the navigator and a video session manager which provides support functionality for the set top terminal. The menu structure has each menu (e.g., menu instructions, graphics and video) contained in downloadable applets which are sent upon request from the service provider equipment to the set top terminal for display. As such, the navigator functions are actually distributed between the service provider equipment and the subscriber's equipment. Such distribution provides an enjoyable, real-time interactive session that allows the user to rapidly navigate through a plethora of menus to find particular information which they desire to view.”

While such approaches partially address the growing need for new services and functions, the limitations of current set-top box technology prevent service providers from offering particularly robust services and functions. It would be advantageous to create an information platform that provides a complete solution for interactive television, that bypasses the risk and delay associated with other solutions, and that offers a wide variety of robust services and functions within the confines of existing or presently envisioned technology.

### SUMMARY OF THE INVENTION

The invention provides a complete solution for Interactive television that bypasses the risk and delay associated with other solutions. The herein disclosed information platform lets network operators, advertisers, and interactive TV developers rapidly use the only open, standards-based interactive TV system. To accelerate content creation and repurposing, the information platform supports widely used and human-readable languages, such as HTML. With the herein disclosed integrated client/server solution, the HTML can reside anywhere on the World Wide Web, thereby simplifying and accelerating deployment of revenue-generating services. The information platform accelerates the deployment of on-demand and subscription services which can not only generate revenue, but also increase customer loyalty, reduce subscriber churn, and therefore maximize return on investment.

The information platform is a client/server system provides a platform for cable system operators to deliver a full range of sophisticated new products to cable television subscribers. Preferably a middleware solution, the information platform provides a flexible, versatile, and adaptable Internet-centric platform that network operators can use to deploy interactive television applications. The information platform mediates the communication between an abundance of Web-based content and the television set. Content and applications are preferably written in industry standard HTML and Java, i.e. interpreted language. Traditional television programming is integrated with Web content using TV-specific extensions to HTML and Java. Applications can be loaded from the network, from carousels, or from file systems, such as flash memory or EEPROM.

The information platform consists of client-side middleware integrated with a native electronic program guide application. It includes a master application that defines service functionality, TV ticker, a suite of games, and a microbrowser for broadcast managed content. The presently preferred embodiment of the information platform supports broadcast-only applications, i.e. applications not requiring a return path, and also provides limited support for two-way applications such as store and forward and imprint server for gathering subscriber interactions and statistics.

### BRIEF DESCRIPTION OF THE DRAWINGS

FIG. 1 is a block schematic diagram showing an information platform overview according to the invention;

FIG. 2 is a block schematic diagram showing the main components of the information platform according to the invention;

FIG. 3 is a block schematic process diagram showing one-way support according to the invention;

FIG. 4 is a block schematic diagram showing a local insertion system for an information platform according to the invention;

FIG. 5 is a block schematic diagram showing a national insertion up link for an information platform according to the invention;

FIG. 6 is a block schematic diagram showing a national insertion down link for an information platform according to the invention;

FIG. 7 is a block schematic diagram showing an imprint logical architecture and data flow according to the invention;

FIG. 8 is a display showing an OMI main screen according to the invention;

FIG. 9 is a block schematic diagram showing components for a television navigator according to the invention;

FIG. 10 is a display showing according a master application home menu to the invention;

FIG. 11 is a display showing a microbrowser screen according to the invention; and

FIG. 12 is a display showing a full-screen ticker according to the invention;.

### DETAILED DESCRIPTION OF THE INVENTION

The following discussion describes the presently preferred embodiment of an information platform that comprises a client/server system, explaining its features, benefits, operation, components, and general technical information. The discussion includes the system and server architecture and describes the information platform's standard suite of applications for enhanced TV.

The inventive client/server system provides a platform for cable system operators to deliver a full range of sophisticated new products to cable television subscribers. Preferably a middleware solution, the information platform provides a flexible, versatile, and adaptable Internet-centric platform that network operators can use to deploy interactive television applications. The information platform mediates the communication between an abundance of Web-based content and the television set. Content and applications are written entirely in industry standard HTML and Java. Traditional television programming is integrated with Web content using TV-specific extensions to HTML and Java. Applications can be loaded from the network, from carousels, or from file systems, such as flash memory or EEPROM. The information platform consists of client-side middleware integrated with a native electronic program guide application. It includes a master application that defines service functionality, TV ticker, a suite of games, and a microbrowser for broadcast managed content. The presently preferred embodiment of the information platform supports broadcast-only applications, i.e. applications not requiring a return path) and also provides limited support for two-way applications such as store and forward and imprint server for gathering subscriber interactions and statistics.

Subscriber Features

The information platform provides the following main features for subscribers:

Web Integration—blending Internet data with traditional television to provide Web pages that are crisp, flicker-free, and readable on a standard TV. This includes support for all common formats and images.

Interactive TV—providing a dynamic environment for the following applications and services:

Managed content browsing

Integration with electronic program guide

TV ticker (news and current affairs)

Games

Interactive electronic program guide (IEPG)

Enhanced television (eTV)

Operator Features

The information platform provides the following advantages to operators:

Value added to the digital cable package, including a competitive advantage in overbuild situations

Turn-key system to help reduce digital churn and increase brand loyalty

New products launched with minimal impact on current operations

Opportunities for increased revenue while amortizing the infrastructure investment

Core set of services designed for maximum flexibility, manageability, and independence

Software and back-end mechanisms to enable growth and product and feature change without affecting customer service Subscriber access to specific interactive features controlled on a tiering basis

New services and applications developed by third-party developers

A truly multimedia and television-centric experience provided to end-users by serving up the resources of the Internet with the look and feel of television

Low latency and fast response times

Information Platform Benefits

The information platform technology uses enhanced client-side middleware combined with a server to deliver superior applications and services. This architecture allows a truly open cable application implemented on the server, or a client application enhanced by the capabilities of the server. For example, Web browsing is made available on the Motorola DCT 2000 set-top box by leveraging the resources of the server platform for layout and rendering of Web content. Some of its more significant benefits are described here.

Enhanced Capabilities

By using the powerful capabilities of an application server, the information platform enables enhanced multimedia applications in current set-top boxes. In a client-hosted solution, the application uses the information platform API to access system resources. The information platform then determines if the service requested can be performed directly on the set-top box using data broadcast from the server. In this manner, the information platform can provide very advanced services on platforms such as the Motorola DCT 2000 set-top box.

Reduced Deployment Cost

The information platform brings the capabilities of next-generation products to current set-top boxes at a very small cost by using the power of a centralized server.

Product Longevity

The information platform enables the development and deployment of full-featured interactive applications, while providing a migration path to more capable set-top boxes.

Central Operation

The application server is an essential element in an interactive television system. It is the gateway to a multitude of services beyond application services. This includes multimedia caching and transaction services.

Variety of Applications

The servers enable the deployment of a larger number of hosted interactive applications than would be possible by current digital set-top boxes (DSTBs).

System Overview

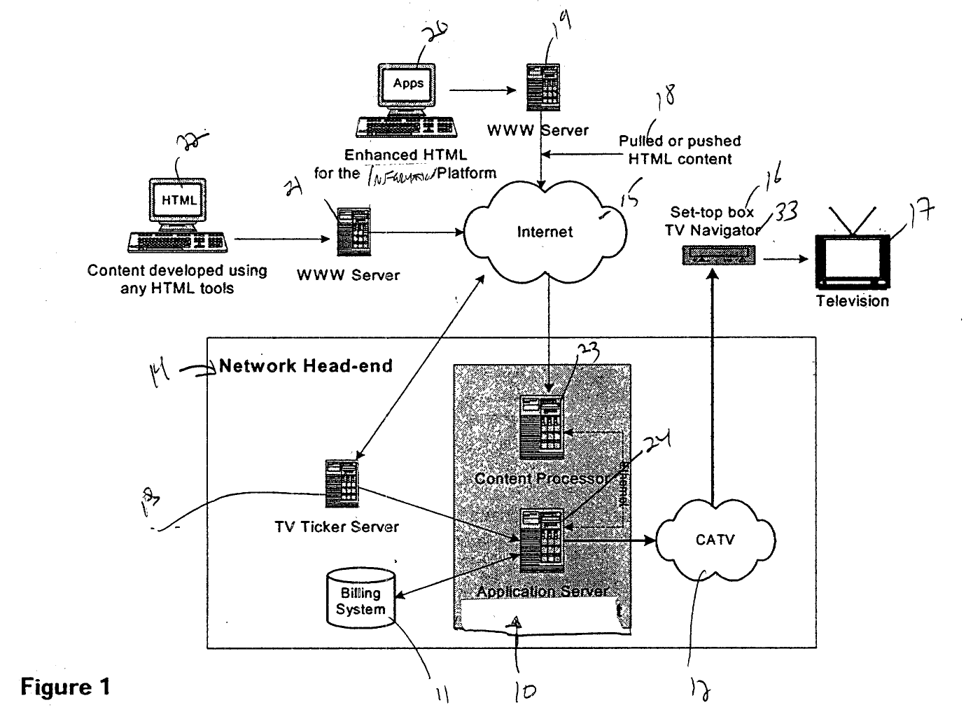

The information platform (see FIG. 1) consists of application servers 10 installed at the network head end 14 and hosted on a Unix platform, and the TV navigator client hosted on a set-top box 16. These components work with the network operator's applications and equipment to deliver proprietary applications, third-party applications, and managed broadcast content to subscribers, along with broadcast television.

A typical system includes the application server 10 which comprises an application server processor 24 and a content processor 23. The application server is typically situated at a network head end 14 and may include such features (discussed in greater detail below) as a TV ticker server 13 and a billing system 11. The application server is situation for exchange of information with a CATV system 12 and the Internet 15. The CATV system provides communications between the application server and the subscriber set-top box 16 on which a TV navigator is running 33 and to which the subscriber's television 17 is connected. The application server is also connected via the Internet to one or more WWW servers 19, 21, which support systems that supply enhanced HTML 20 to provide pushed or pulled HTML content 18 to subscribers; and systems 22 which supply content that is developed using any HTML tools.

The following discussion introduces the application server components of the application server processor and TV navigator, and important components supplied by the network operator.

Application Server Suite

The presently preferred application server is a suite of POSIX-compliant Unix-based software developed primarily in C. The application server is installed at the network operator's head end, and fully integrates with existing equipment and processes. It preferably runs on Solaris and Linux, and is portable to other Unix systems, such as AIX or HPUX. The application server uses Intel-based and Sun Enterprise server groups, each of which is able to support a large number of concurrent users.

The application server groups may be assembled to create a large fault-tolerant, scalable information platform system, serving many thousands of concurrent users. Application servers are logical units, and do not necessarily correspond to the number of physical machines deployed. For example, there may be a single application server on a single computer for a small deployment, or a server may be instanced on many computers for scaled-up deployment. Applications and content-processor software can use a common host server, or separate host servers. Each physical server includes a common infrastructure of supervisor processes, statistics, and event-logging servers.

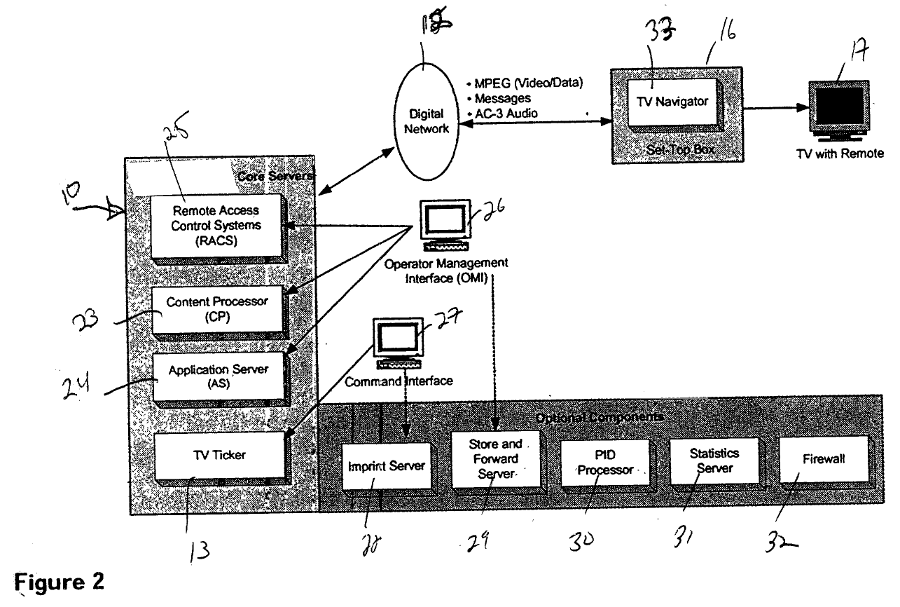

FIG. 2 is a block schematic diagram showing the information platform main system components, which comprise:

Core Servers

The core set of application servers 10 consists of:

Remote Access Control Systems (RACS) 25—RACS allows secure access to the system for troubleshooting and monitoring. It also acts as the proxy for the content processor and for HTML content.

content processor (CP) 23—CP retrieves and transcodes HTML broadcast managed content into I-frames, and data to be displayed by the microbrowser (discussed below) on the set-top box 16.

Application Server (AS) 24—AS is the heart of the system, the application sever hosts a variety of processes including:

Supervisor

Supervisor monitor

Log Server

Host monitoring server

Information Mediacast (data carousel server and multimedia streamer)

Data carousel update server

Broadcast managed content server

TV ticker 13—TV ticker formats news feeds from the Internet 15 (FIG. 1) to headlines and stories to be displayed on the television 17. The headlines are transmitted in the out-of-band and the stories are transmitted in the in-band.

Optional Components

Optional components to enhance and add functionality include:

store and forward server 29—The store and forward server collects statistics from the clients and forwards the messages to the imprint Server.

imprint server 28—The imprint server gathers statistical information based on user interaction with the information platform.

statistics server 31—The statistics server organizes records and statistics generated by applications and processes, and writes them to downloadable text files.

PID processor 30—The PID processor combines messages on two different PIDs to allow interactive services to be enabled on the DCT2000.

firewall 32—The firewall allows secure remote access to the system for troubleshooting and system monitoring.

Monitoring Application

The information platform provides tools and support for the remote management of a head-end server:

Operator Management Interface (OMI) 26—Remote management of the core servers is performed using the operator management interface (OMI). OMI is a platform-independent graphics-based monitoring and management tool. Basic functionality includes:

Starting and shutting down the system

Viewing log messages (Severe, Warning, and Regular)

Status alert notification and exceptional condition reporting

Content updating

Disk and CPU usage reporting

Command 27

Command is a browser-based tool for configuring, monitoring, and maintaining the TV ticker and imprint servers.

Simple Network Management Protocol (SNMP)

The information platform software supports the simple network management protocol (SNMP) reporting of exceptional conditions and may be integrated with any SNMP-compliant network manager tool, such as Hewlett Packard's OpenView or IBM's Tivoli.

Web Content Collection Process

The information platform converts Internet content and protocols into forms suitable for TV viewing. The content is fetched from Web sites, converted or rendered by the system, and then cached on application server The information platform supports content from standard Web sites, e.g. HTML source, GIF, animated GIF, JPEG, and PNG files. The majority of HTML 3.2 tags are supported, e.g. text, tables, forms, images, image maps, background images, and sounds.

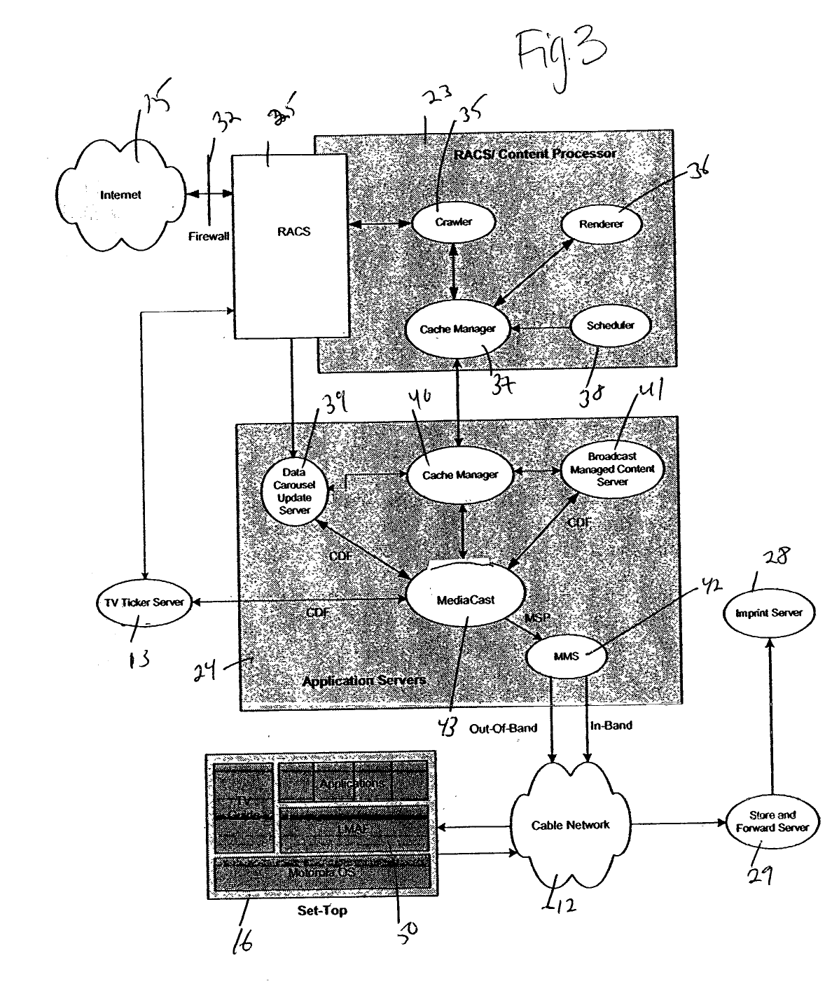

The process of collecting, caching, transcoding, and delivering content is shown in FIG. 3. Typical data flows are indicated by the arrows connecting the components.

Server Scalability

The information platform employs a simple and effective strategy for server scalability using server replication. Multiple servers can be replicated within the application server, forming one logical server. If a server is overloaded, the system administrator can add more servers to the server group. If a server fails, transactions are routed to another server in the server group. As many servers as necessary can be used to meet the load-balancing requirements of the service.

Server and Network Fault Tolerance

Fault tolerance is an important aspect of any online high-availability system. The information platform is configured to handle many types of system failures—both software and hardware. The presently preferred application server runs on UNIX hardware, such as the Sun Enterprise class of servers. Sun (and others) provide redundancy, RAID storage, cable and Internet network interface hardware, and associated software. The entire hardware platform can be protected by an uninterruptable power supply and surge protection. Should a power outage occur, however, the system is configured to restart at power up. The application server monitors each software component and recovers from failure according to a specified configuration. This could include restarting the failed component, or restarting the entire system as necessary. Note that the application server also includes the ability to load-balance between active servers so that, in addition to failover support, the servers in a cluster can be maximized for increasing overall performance. The network itself may also be configured with redundant network components, such as duplicate switches and interface adapters. As a result of the multiple layers of redundancy, the total system presents very high availability to its users.

TV Navigator (Client)

The TV navigator is a middleware layer. The preferred embodiment is written in C and Java, and runs on digital set-top boxes, such as Motorola's DCT 2000.

The presently preferred client consists of the following applications:

Middleware—The middleware platform supports multiple running Java and native applets, each sharing the resources of the set-top device. It includes:

The microVM application environment (LMAE) 50, which is a Java compatible virtual machine. It contains the Micro Java compatible API set, and API extensions for the television and broadcast environment

Sandbox, which is an execution of Java compatible applications that provide application level security

Features such as enhanced television (eTV)

master application—This is the interface that allows interaction with all the other available services. It is also responsible for security, tiering, and other services.

microbrowser—The microbrowser displays and navigates HTML content that has been transcoded by the content processor and then broadcast via the Mediacast component.

TV ticker—TV ticker is a bandwidth-efficient broadcast news service. It displays headlines and stories over a broadcast channel.

Games—This is a suite of proprietary and third-party games.

electronic program guide integration The TV navigator is integrated with the native electronic program guide application to provide TV listings and channel-tuning functionality.

End-to-End System Architecture

The existing digital TV cable network infrastructure connects the set-top box to the application server. The downstream communication, from server to set-top box delivers an MPEG transport stream containing MPEG video, MPEG audio, and data via a specialized hardware multiplexer card. The information platform can be configured to service a local cable system, or a national system with satellite up- and down-links.

Local System Insertion

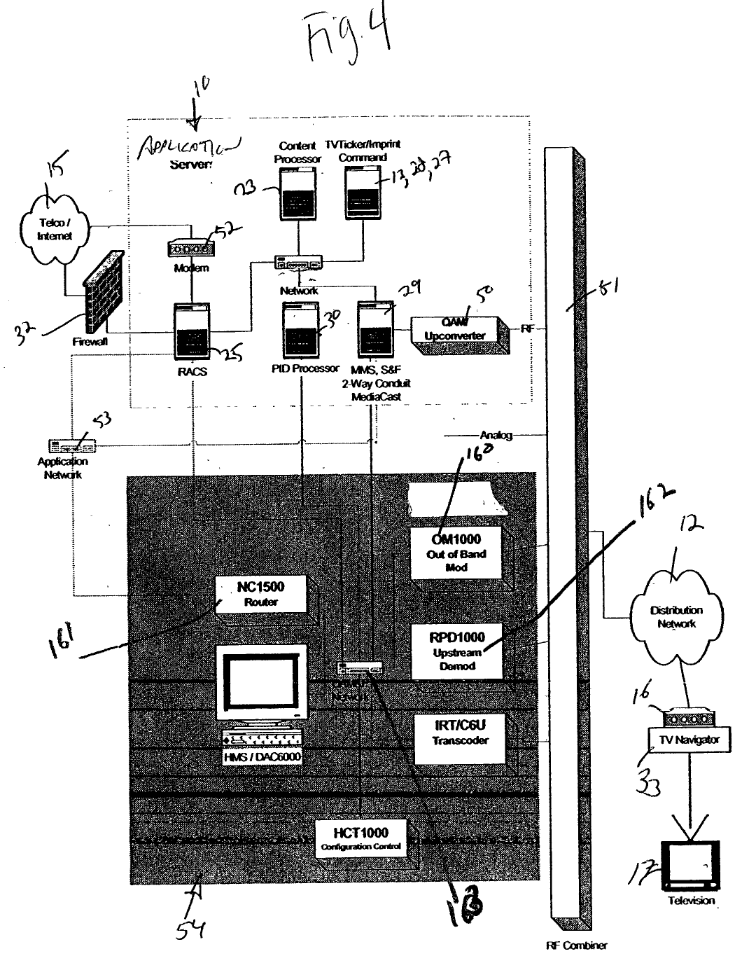

FIG. 4 shows the network connections between the application server and the network operator's head end equipment. It also shows the flow of content and interactive services from the head end to the TV Navigator client on the set-top box. Note that the head end equipment shown in FIG. 4 is described in detail below.

A national system can deliver broadcast services to multiple head-ends from one set of servers.

Uplink

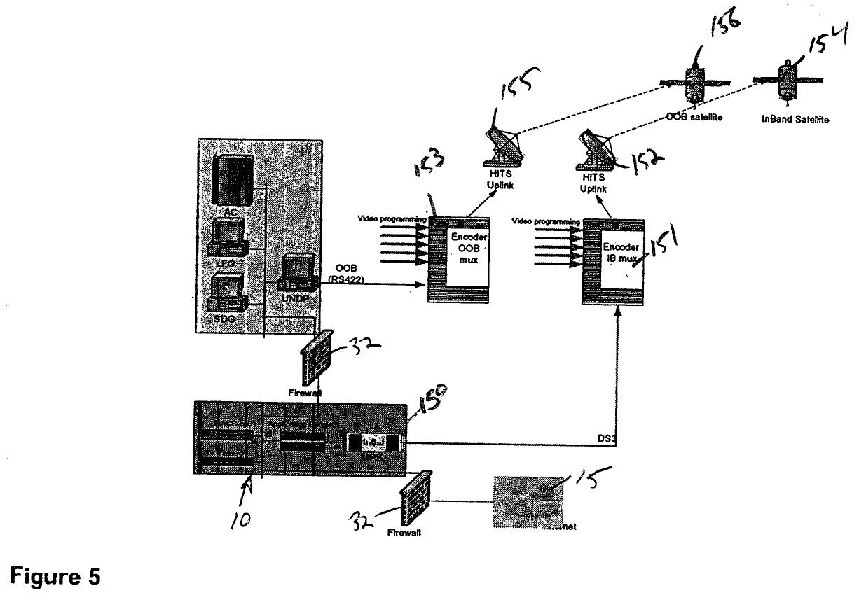

FIG. 5 is a block schematic diagram that shows the information platform, national insertion up link. The application server 10 is installed at the network head-end. Inband content goes through the broadband feed 150 to the encoders 151, then is up linked 152 to the satellite 154. Out of band content goes through a separate encoder 153 and is uplinked 155 to a different satellite 156.

Downlink

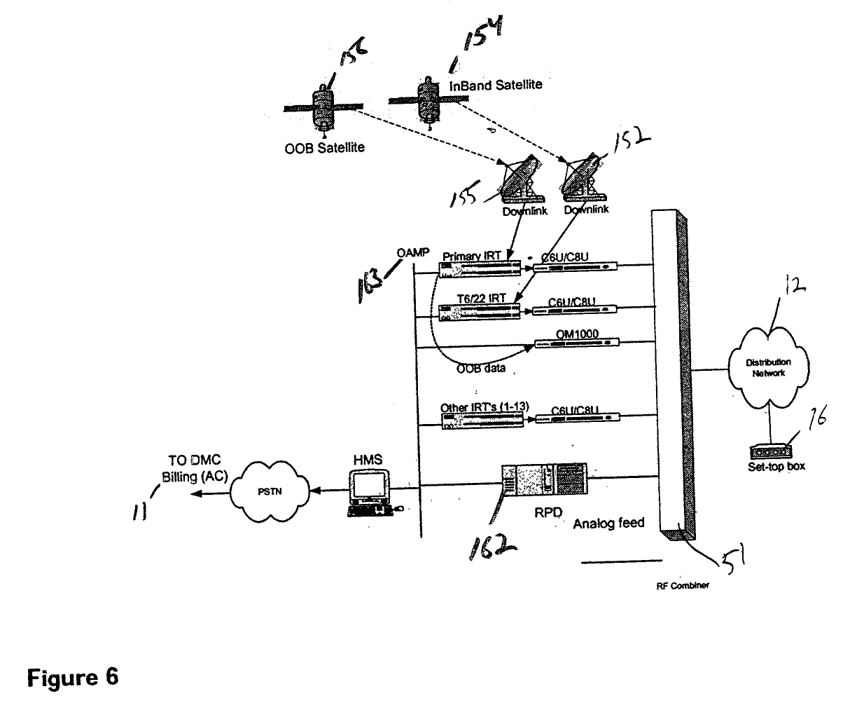

FIG. 6 shows the data path through the down link and out to the set-top box.

The down link site must have the following (see FIG. 4):

QAM Modulator/RF Upconverter 50

OM2000 Out-of-Band Modulator 160

NC1500 Network Controller 161

RPDx000 (Reverse Path Demodulators) 162

OAM&P Network 163

Application Server

The application server relieves the client of the processing and storage burden required to support rich Internet functionality. The application server transcodes Web pages into a format that is viewable on the set-top box. The server integrates with the network operator's existing headend equipment, network management systems, billing systems, and customer service systems. Built upon standards-based protocols and Internet servers, the application server is scalable, manageable, and reliable.

The information platform allows network operators to provide services such as:

Broadcast managed content browsing

Applications such as Games, electronic program guide, and TV ticker

The information platform supports HTML 3.2, including text, tables, forms, images, animated images, image maps, frames, and background images. HTML has been extended to support Interactive TV applications.

System Architecture

The servers and processors that make up the application server are deployed on Solaris and Linux machines. The number and configuration of the machines depends on the type of deployment and the size of the system (see FIG. 3). Application servers 24, content processors 23, and multimedia streamers (MMS) 42 are specific to the Information version of the application server platform. Each hosts a subset of the application server software processes. The imprint 28, TV ticker 13, store and forward 29, and command servers 27 are included in the architecture, but are not Information-specific.

Application Server

The application server is a machine that hosts the core servers of the information platform. A typical application server hosts the following processes, which are described in detail below (see FIGS. 2 and 3):

Supervisor 41

Supervisor monitor

Log server

Host monitoring server

Statistics server 31

Information Mediacast (data carousel) server 43

Data carousel update server (DCU) 39

Broadcast Managed Content Server Supervisor

The supervisor is the first process started on the host running the system. It starts and monitors all of the processes during the system's lifetime. The supervisor is also the name server for the system. Processes register their socket host and port with the supervisor, and supply a name by which other processes can look them up. When a process in the system terminates for any reason, the supervisor performs a recovery based on the entry for that process in the configuration file.

This recovery can involve:

Logging that the process has terminated

Restarting the process, perhaps after a specified delay time

Shutting down the system

The supervisor also supports notification. A process can request that it be notified when another process terminates. The supervisor monitors resources, such as memory consumption and CPU usage, and can either generate warnings or terminate errant processes that exceed preset limits. The supervisor also checks process integrity with heartbeat messages and either warns or terminates processes that timeout their heartbeat response.

Supervisor Monitor

The supervisor monitor starts and stops supervisor processes. All other processes are owned by the supervisor. Should the supervisor terminate with an error condition, all servers and applications are shut down. If the restart environment variable is set, the supervisor is restarted. If the supervisor terminates properly, the supervisor monitor process also terminates.

Log Server

The log server provides a generic logging service to all system and applications processes on the server. Each host runs its own log server. The received log messages are buffered and written to the log file on a periodic basis. When the number of messages in the log file has reached a maximum value (configurable), a new log file is started and the old file is archived.

Host Monitoring Server

The host monitor server monitors essential components and logs warning or severe messages when these subsystems fall below a set level.

The host monitor server is capable of monitoring the following three components:

File Systems—Monitored for available free space and free nodes, in absolute size and in percentages of total. Warnings are logged when these values fall below critical levels.

Memory—Monitored for available free space, in both absolute size and percentage of total, including both swap and real. Warnings are logged when this falls below a critical level.

CPUs—Monitored for their load, as given by 100%—idle-time percentage. Warnings are logged when the CPU load remains above a critical level for a certain amount of time.

Statistics Server

The statistics server organizes records and statistics generated by applications and processes and writes them out to disk as text files. The records can be downloaded from the head-end for analysis at regular intervals. These records are easily imported into tools that can be used to analyze the data. When a process wishes to record statistics, it sends a request to the statistics server, which returns a handle representing the file into which the records are written.

Subsequent requests to write statistics records must contain this handle. In this manner, a single process can write records to multiple files. The statistics server may reside on a different host than the process generating the statistics and may serve several hosts that have statistics-generating processes. Statistics messages are sent using the asynchronous send routine from the IPC API. Using the asynchronous method, statistics-generating processes do not have to wait for the statistics server to respond before continuing. This improves overall response time and makes the system tolerant to faults within the statistics server. Client applications, such as the microbrowser and TV ticker, have their usage statistics collected by the imprint server, which requires a two-way return path, described below.

Mediacast (Data Carousel) Server

The information Mediacast™ server manages requests to transmit the carousels of data and image files. Information Mediacast is composed of the data carousel server for data formatting, and Multimedia Streamer (MMS) components for data transmission. The data carousel server delivers data and multimedia resources to set-top boxes using one-way (downstream) communications. An unlimited number of clients may access the system without increasing the downstream bandwidth required.

The data carousel server supports three types of carousels:

data carousel—This carousel stores any resource, for example, images, applets, configuration files.

Trigger data carousel (TD)—This carousel is similar to the data carousel, but any applet stored on this carousel can also be associated with file triggers, for enhanced TV, on a trigger carousel.

Trigger Carousel (T)—This carousel stores eTV triggers.

The data carousel server creates objects in the Mediacast signaling protocol (MSP) format, and uses the multimedia streamer (MMS) components to transport the MSP objects to the downstream network. Carousels are updated via posting of CDF.

The primary functions of the data carousel server and the MSP are to:

Broadcast a list of names and locations, e.g. file system or URL to resource location

Deliver named data resources, e.g. JAVA applets, HTML content

Reference named video resources, e.g. MPEG still I-frames, P-frames

Reference named data resources (unspecified private-text)

Group resources together in named entities called MSP namespaces; these groupings may relate resources to an application

Support multiple protocol bindings for multicast IP, Digicipher II, and MPEG private sections.

Provide integral failover mechanisms

Mediacast Signaling Protocol (MSP) Objects

An MSP namespace consists of a set of carouseled objects. An MSP namespace has a name, and one directory tree, with one root directory. An MSP namespace can span one or more transport locations. There may be more than one namespace available to a client. The MSP namespaces, carousels, and transports are configured via an XML configuration file.

There are five types of MSP objects:

Data objects—Data objects contain raw data resources.

Directory objects—Directory objects form a list of resource locations, and can reference other directory objects, data objects, audio and video resources.

Notification objects—Notification objects contain a list of objects that have changed and give the client a general mechanism to determine if a resource has changed using minimal hardware filtering. They also facilitate directory cache construction.

System information objects—System information objects contain the locations of MSP namespaces, associate a name to an MSP namespace, and locate the entry point of the directory tree associated with it.

MSP Transports

MSP objects may be transported in a variety of ways. In the application server, one or more MSP blocks are contained within a DCII private_stream_message section. Private-text packets are then encapsulated into MPEG transport stream packets, and are carouseled by the MMS inband or out-of-band MPEG transport streams.

Multimedia Streamer (MMS)

A multimedia streamer (MMS) consists of the audio/video/terminal server (AVTS) that delivers the units of audiovisual information sent by the system to the user's set-top box. It also contains the out-of-band servers (the MMS_OM1000) and the downstream router (DSR). An external MMS also requires a cache manager to transfer content from the application server (AS) or content processor (CP) to the MMS. In general the MMS is hosted as an AS which eliminates the need for additional content transfers.

AVTS Audio and Video Services

The AVTS is responsible for delivering MPEG video and Dolby AC-3 audio streams to the set-top box. A special MPEG multiplexer (MUX) card, controlled by the AVTS, streams data onto the cable network.

In its video and data roles, the AVTS provides the following:

Ability to play full motion video files

Ability to play MPEG I-frames (full-screen images)

Ability to play MPEG B-frames (MPEG “layer”)

Ability to play MPEG replacement P-frames (subscreen sized images)

Ability to play MPEG motion vector P-frames

P-frame effects:

Full-screen smooth scrolling in four directions (scroll command)

Partial-screen smooth scrolling in four directions (xpanel command)

Play a group of (strictly nonoverlapping) replacement P-frames (post)

Construct an I-frame from various FMB file sources (with optional P-frame updates played afterwards)

Ability to send in-band data

Ability to pause or resume, fast forward, and rewind full-motion video

MPEG Card (LMC)

The information platform uses the information platform drop and insert LMC. An information platform PCI adapter based on the PowerPC CPU performs the MPEG multiplexing. The information platform drop and insert LMC is capable of accepting one input and producing four output streams. Each output stream is generated independently so users on different cable system segments can be isolated, thus expanding the bandwidth available per segment. Drivers for LMC are available for SPARC Solaris. The LMC board is a PCI-based adapter card that is MPEG-2 transport stream compliant and can concurrently transmit and receive MPEG-2 transport streams. The board uses the PowerPC 403GCX as its on-board processor. The primary on-board memory is high-speed SRAM with a 128 MB-per-second burst rate. The on-board processor off-loads scheduling of user data requests from the host system.

The LMC performance can be summarized as follows:

100% usage of four concurrent MPEG-2 streams at the 64 QAM rate of 26.97 Mbps or the 256 QAM rate of 38.81 Mbps.

The four output streams can be combined using the information platform interface translation PCI board to form single DVB-ASI stream with up to 107.88146 Mbps payload data rate (DVB-ASI transport rate is 270 Mbps)

LMC's flexible architecture can accommodate numerous applications with features that include:

Real-time playing and recording of MPEG-2 streams (operations can be simultaneous)

Real-time analysis of MPEG-2 transport streams

Real-time program extraction

Real-time program insertion

Delayed transmission of MPEG-2 streams (stream buffering)

The supported interface for single input is DVB-SPI (LVDS).

Supported interfaces for four outputs include:

DVB-SPI (LVDS)

DHEI

TAXI

DVB-ASI (Coaxial)

DVB-ASI (Fibre Optic)

MMS_OM1000

This server communicates with specialized hardware to deliver out-of-band data, such as updates to the set-top box internal data store, to the set-top box. Any request that can be sent via the in-band data channel may be sent out-of-band. Generally, the MMS_OM1000 is used to send OOB directories and files, subjecting all data to rate-throttling to prevent buffer overflow in the set-top boxes.

The data may be:

Broadcast to all set-top boxes

Multicast to a group of set-top boxes

Single-cast or “addressed” to a single set-top box

Downstream Router (DSR)

The downstream router manages the routing of out-of-band messages to the appropriate communications facilities (MMS process) for transmission to the set-top boxes. In a small cable system, a minimal information platform head-end has a single Out-Of-Band Modulator, such as the Motorola OM1000, to deliver all out-of-band downstream data to the set-top boxes. To provide scalability for larger cable systems, or if smaller cable systems are consolidated for servicing by a single information platform head-end, multiple out-of-band downstream channels are required. The downstream data traffic generated by application server is routed to the correct Out-Of-Band modulator for transmission to the appropriate set-top boxes by the downstream router (DSR). Application processes communicate directly with the DSR, and the DSR routes the messages to the proper MMS_OM1000. There is one MMS_OM1000 for each Out-Of-Band modulator used by application server.

Smart Caching

Cache managers 37 (see FIG. 3) are responsible for accepting requests for content and handling the steps required to deliver the content to the necessary location. Once content is pulled from the Internet, the crawler 35 deposits the unrendered content (HTML, JPEG) into source cache. The rendered 36 cache is a storage area for content that has been converted into a particular form (MML). Because the scheduler 38 instructs the crawler to pull content on a scheduled basis, a prerendered copy is typically found in the source cache, and the rendered copy is found in rendered cache. When a process needs to fetch content, it requests the local cache manager to resolve the URL for the content.

The cache manager checks the local rendered cache for the content and notifies the application if the content is present. If the content is not local, the cache manager must resolve the URL. To resolve the URL, the cache manager sends a message to all cache managers on content processor hosts that have been configured to resolve URL requests. They are running on hosts with a crawler and renderer. The content processor cache managers all check their local caches for the requested URL and reply with the timestamps and status for their local source and rendered caches. In addition, the current workload of each content processor cache manager is returned to the cache manager.

The cache manager then implements information platform's smart caching by evaluating the status of all the caches and selecting one of the following mechanisms to best fulfill the application's request:

If valid content resides in a rendered cache of one of the content processors, the cache manager immediately copies the content to the rendered caches.

If the valid content is in a source cache, but not rendered, the cache manager first directs the cache manager on the content processor to render it and then copies the content to the rendered caches.

If the content is not in a source cache, the cache manager directs the least busy crawler to get the source and render it, and then copies the content to the rendered caches.

Once the CM finishes the copy, it responds to the application. The application uses the content, assured that the proper content is in the rendered cache.

Content Processor (CP)

A content processor (CP) cluster produces digital cable system compatible (rendered) content from standard Web content retrieved from the Internet. Multiple content processors operate in a CP cluster to provide load-balanced, distributed rendering. The rendered content is made available to all the application and MS processes by the distributed, smart caching subsystem. content processors consist of Intel multi-CPU servers running Linux, or Sun servers running Solaris. Each CP requires a standard set of information platform processes to integrate with the information platform. These processes are the supervisor, Log server, and cache manager. CP processes involved in accessing the Internet and rendering content are the scheduler, crawler, and renderer server and renderer agents. Content is rendered in response to scheduled requests, which are initiated according to a schedule file. The schedule file lists the content and the fetch timing. The specific processes of the content processor are discussed individually below.

Crawler

The crawler responds to batch fetch requests. Batch fetch requests are initiated by the scheduler according to its schedule file. The crawler ensures all content for a request is pulled and stored on the server. It also performs limited post-processing of the crawled content, such as converting http: to file: and adding meta-tags for specific HTTP header information.

The crawler's specific functions are to:

Crawl the Web to fetch HTML documents and their referenced assets

Place the crawled assets in the appropriate source cache directory on the server

Reply with crawler progress messages to the requesting client

Recursively fetch content down to a specified level from a base URL for batch crawls

Handle form submissions

Crawler Semantics

The crawler is intelligent about fetching data from the Internet. When instructed to fetch an HTML document, the crawler only fetches the document if it is newer than the one on the application server, based on the modification dates provided by the Web server. When the crawler checks the modification dates of the content referred to by the HTML document, it loads only those files that are absent or whose modification dates are newer than the versions on application server. If the assets have changed, they are fetched. Once new data are fetched, the requester is informed because it is likely for the requester to request a re-render of this content. The crawler also supports a mode where a fetch is performed regardless of whether the content has changed or not. This mode can be used when accessing sites that are known to return incorrect modification times from the Web server.

Scheduler

The scheduler ensures that content is fetched, rendered, and copied to the appropriate locations for use. The scheduler triggers an update through the cache manager. The cache manager, in turn, manages the fetching (via the crawler) and the rendering (via the renderer) on a scheduled basis. Information about when to fetch from which Web sites is contained in a configuration file. The scheduler manages the fetching of HTML and application data. HTML is fetched and rendered as it arrives. Once crawling and rendering is complete, the cache manager responds to the scheduler, which oversees any post-processing of the Web content.

Post-processing varies depending on the Web content. Thus, the scheduler is provided with post-process methods specific to each entry. This program (which may be a binary program or script) may be run before or after the finalization step, depending on what is specified in the configuration file. The file format used by the scheduler, is similar to the file format used by the Unix “cron” system. Comment lines begin with a # (pound sign). The file contains information about which URL to crawl and when.

Renderer

Most content requires rendering before it can be displayed on the set-top box. The renderer converts the content into a format compatible with the user's set-top box hardware. It does this by accepting URLs of HTML files that are stored locally, and then parsing and rendering the HTML to produce output image files (FMB) and output CPML or MML.

Operation Modes

The renderer operates in batch mode. Batch mode is for rendering pages that are not currently being requested by a user but are prescheduled to fill the rendered cache. Batch mode is noninteractive broadcast managed content uses the batch mode only. The renderer also supports a layout preview mode that emulates a system running the microbrowser. All the pages for this mode are limited to a single screen of information. All pages longer that a single screen are clipped at the bottom. In this mode, there is additional information displayed below the screen capture. It includes the size (in bytes) of each asset, produced by this page, that are broadcast by the Mediacast server and whether the background I-frame is modified or not.

Information Platform Layout Engine

The information platform layout engine processes HTML documents and allows expansion to other document types. All requests to render HTML pages result in a translation of these pages to CPML, and the production of an FMB file containing the MPEG compressed page information. The CPML file contains a description of the result of the information platform layout engine placement policies. The information platform layout engine placement policies produce TV-centric layout of document elements, optimally arranging the content in the output buffer prior to compression to MPEG format. The CPML file identifies the locations and layout of important document assets (animations, hot zones, links) required by application server applications and server processes. All important page assets are described by using the CPML constructs such as anchors, form elements, and animated GIFs.

After layout, the information platform renderer quickly and effectively compresses the output buffer to MPEG syntax in the FMB file format. All dynamic objects, such as form elements, are laid out on MPEG macro-block boundaries, having been scaled to the appropriate 16×16 pixel block boundaries where necessary. The FMB file is guaranteed to have the same width as the TV screen and the height is guaranteed to be at least the height of the screen. The FMB file information is efficiently transcoded to one or more MPEG frames for transmission to digital set-top boxes.

Standard Web-Based HTML Rendering

The information platform layout engine supports HTML 3.2 specification. Almost all the HTML 3.2 tags are supported. The only exceptions are scripts and applets. The information platform layout engine is preferably extendable to HTML 4.0.

Microbrowser Rendering

The information platform uses the thin client model to provide a Web browser on digital set-top boxes that would otherwise be too slow. In the thin client model, a server performs the major part of the processing work, off-loading the client and permitting superior performance for complex activities.

The system's typical operation is as follows:

1. A server fetches content from the Web and performs the initial translation, layout, and rendering. The server caches the converted content for future reuse, and crawls the Web as configured by the server administrator to refresh the cached data.

2. The server continuously transmits the Web data to the client in an MPEG video stream. The server puts images of the rendered Web page in MPEG I-frames and MPEG P-frames. In addition, the server transmits some additional information about the Web page's characteristics in an MPEG data stream. This additional information defines foreground text, hotzones, and hyperlink URLs. This is contained in an MML tile that is transcoded from the original HTML.

3. The digital set-top box already contains dedicated MPEG hardware for video and audio decoding, so it uses the same hardware to decode the MPEG data from the server. This frees up the set-top box's central processing unit (CPU) to perform other tasks.

4. The client software uses some of these freed-up CPU cycles to run a small but powerful microbrowser that interprets the contents of the MML tile. MML provides simple commands for drawing lines and text. In combination with the MPEG image data, MML lets the user navigate hypertext links.

Cache Directory Structure

Every rendered presentation resides in its own directory. The name of the directory is composed of the rendered cache prefix and full URL of the presentation. For example, the URL http://www.liberate.com/index.html resides in the directory /prefix/www.liberate.com/index.html/, and all the files are contained there. Within the directory is the CPML file, the main FMB file containing rendered images, and one or more subdirectories containing the rendered assets (animated GIFs, form elements) for the given CPML file. Taking this example a step farther, if there is an animated GIF on the same page, with a URL of http://www.liberate.com/images/anim.gif, it is rendered as separate frames into the /prefix/www.liberate.com/images/anim.gif/directory. Each frame is called fmb.TIMESTAMP.seqence_number. The same scheme holds for all special assets of the presentation (animated GIFs, forms, frames).

The following discussion provides a background on the context in which the cache control and update mechanisms operate.

Broadcast Managed Content Browsing

The information platform uses a managed-content approach to provide an intranet-like service for television subscribers, allowing them access to a controlled set of services and content—rather than providing subscribers with full Web access. Navigation is restricted to following the hyperlinks. The sites featured within the managed content have disabled the hot links that lead users off the site. Using managed content lets operators and their strategic partners present subscribers with a collection of valuable, aggregated Web sites specifically tailored and enhanced for television viewing. Direct URL entry from a wireless or virtual keyboard is not permitted, and the Internet is only checked for content updates on sites that are registered in the scheduler. This closed content environment offers promotional opportunities for the operator along with a means of generating revenue, as content providers and advertisers pay for exclusive access. All valid managed content is rendered to MPEG and MML format in the content processor cache, as required. The converted content is then posted to the Information Mediacast server for MPEG transmission and display on the user's set-top box.

Scheduled Updates

A scheduled content update mechanism is provided via server configuration files, which allows content to be retrieved and converted periodically to MPEG in the content processor cache before a user request is generated. This facility is maintained at the server by the system operator. It allows the content processor cache to be preloaded with content, eliminating the Internet access and conversion latency for the initial access to that content when next requested by a user. The transfer latency to the displayed cache is small relative to the Internet crawl and MPEG conversion steps.

Store and Forward Server

The store and forward server enables Java applications running on the client to send non-priority data to any server on the application network.

This could include:

Client application usage statistics sent to a database on the application network

E-commerce purchase information sent to the destination Web server as if the purchase had taken place on the Web

Note that any data the proxy server sends to the set-top box is sent as a UDP packet. This UDP packet is received by the NC1500 and sent downstream to the set-top box via OOB. For this to work correctly, a route (or routes) must exist for the set-top IP addresses to the NC, which is the gateway to the OAM&P network where the set-top boxes reside.

The store and forward mechanism consists of two distinct parts:

Client-side code in the microVM

Server-side proxy server processes

Imprint Server

The imprint server enables operators to gather statistical information on user interaction with the information platform.

Statistics are collected for the following:

Master Application. These statistics include the duration and exit time for all applications, master application menu display, and eTV icon display.

TV ticker. These include such statistics as the category that was viewed and the length of time that a story was viewed.

Microbrowser. These include such statistics as the URL that was selected, and the duration at URL.

Imprint Architectural Overview

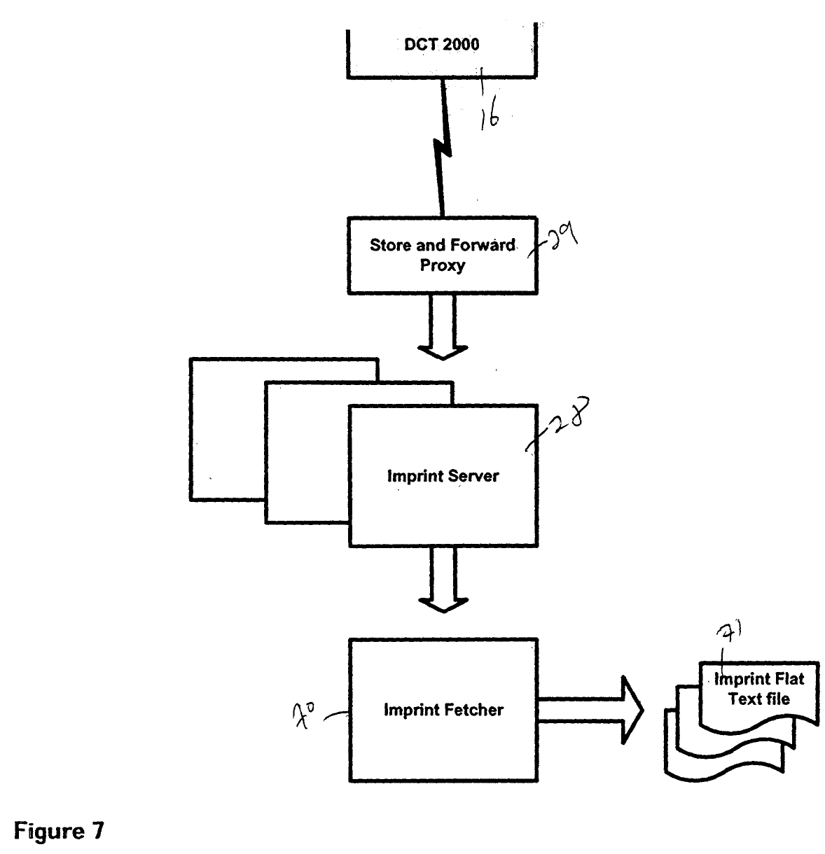

FIG. 7 depicts a logical view of the steps involved in collecting user events from the set-top box to generate a text file of statistics.

The imprint server architecture consists of:

Stats API—This is middleware that resides on the digital terminal. It facilitates the gathering of user events from different applications For example, when a user selects the guide application from the master application, an event is sent from the set-top box 16 to the Stats API. The Stats API then sends these user events to the store and forward proxy 29 in a batch.

Store and Forward Proxy—This is a server-side construct that facilitates upstream communication for the digital terminal via the NC1500. When user-event data is received by the proxy, it is converted to a standardized format by the store and forward proxy imprint plug-in and then sent to the imprint server 28.

Imprint Server—This is the Netscape Server Enterprise plug-in that facilitates HTTP communications from both the imprint client and the imprint fetcher 70. When contacted by the store and forward proxy, it reduces the received information into single events and saves them in a flat text file 71.

Imprint Fetcher—This is a daemon that collects data from one or more imprint servers and saves it in a central log file.

Imprint Data Bridge—This is a utility that can be used to import the flat file into the database.

Monitoring and Control

Operator Management Interface (OMI)

The operator management interface (OMI) provides centralized management (from local or remote locations) of configuration information for all information platform servers. The interface operates over an Internet connection to a Unix-based server.

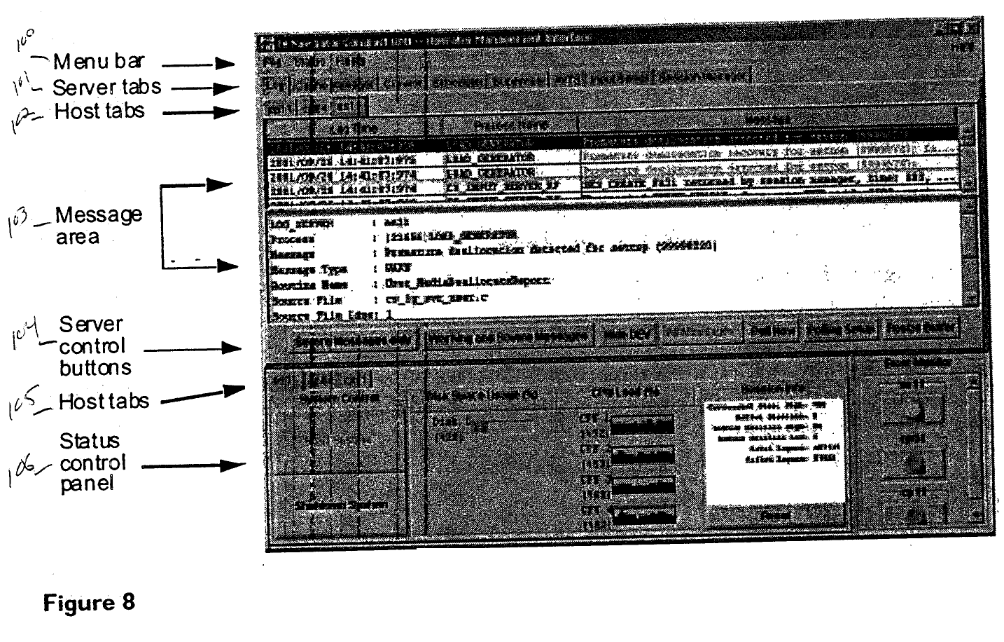

The OMI is a utility implemented in Java to monitor and control the application server. The OMI provides the capability to view log messages, start up and shut down the system, monitor and terminate user sessions, and monitor downstream bandwidth. Because the server is running on the Unix operating system, the complete suite of Unix tools and utilities are available for problem determination and resolution. This includes snoop, telnet, ftp, and others. A character-based tool similar to the OMI is also available for those with limited access to the server. An information platform operator uses the graphical OMI to configure and monitor an application server (see FIG. 8). The graphical OMI provides such features as a menu bar 100, server tabs 101, host tabs 102, a message area 103, server control buttons 104, host tabs 105, and a status control panel 106.

Using OMI, operators monitor system activity and perform certain administrative duties, including the following:

Monitor the system status. OMI monitors system resources.

Start up or shut down the system. If instructed by Technical Support, an operator may shut down and subsequently restart the system. If a staged shutdown is required, the operator may use the Input server interface to block any new logons.

Display log messages. OMI displays recorded log messages. The operator may highlight a log message to view details about that message.

Display sessions. OMI displays the number of users currently on the system. It also lists all user sessions and displays the controlling application.

Clear sessions. An operator may clear an existing session through the OMI Session Manager panel.

List registered applications and media servers. OMI lists the applications and media servers that have registered with the Session Manager.

Display the scheduler file. OMI lists the scheduled fetches along with active fetches currently being performed.

Trigger scheduled fetches. Operators may manually trigger a scheduled fetch.

Add, change, or delete a fetch. Operators may add a fetch to the scheduler file, delete a fetch, or change existing fetch details.

Fetch on the fly. Operators may trigger an unscheduled fetch.

Monitor system performance. Operators can use the AVTS panel to monitor system bandwidth to ensure acceptable performance.

Manage cache. Operators can see how system cache is being managed and purge cache using the cache manager. Typically, problems are detected by monitoring the OMI for server log messages. The operator can then telnet into the system and fix the problem, or restart the system through the OMI. The system is also capable of detecting fatal faults and restarting itself without human intervention. Much of the fault tolerance is configurable by the system operator.

Command

Command is a browser-based interface for configuring, monitoring, and maintaining the TV ticker and imprint servers. It allows the user to perform most server maintenance functions on a regular or occasional basis. Command does this by keeping track of which software packages and servers are installed on which machines. Command can be accessed from browsers on Solaris workstations or PCs.

The Command server uses the following communication protocols:

XML transmitted over HTTP to talk to the other application servers. Each server has unique XML-based schema for describing configuration information.

JDBC to communicate with the command database. Command uses an Oracle RDBMS to store configuration data. Standard tools can be used for performance tuning, load balancing, viewing, mirroring, and backing up the database.

As the network operator enters changes in command, the new parameters are stored in the command database but are not immediately propagated to the servers. The servers must be updated or restarted from the “Monitoring and Control” panel to apply the changes. The servers do not need to be rebooted after receiving new configuration information.

Command communicates with the TV ticker server in the following manner:

1. The TV ticker server identifies itself to command at startup and requests its configuration information.

2. Command authenticates the server, verifying that the server is permitted access to the requested configuration information.

3. Command transmits the configuration information, allowing the server to successfully start up and operate. Each server also caches its last known configuration information in a local file, allowing the server to start up and operate in the event that command is offline.

TV Navigator

TV navigator is a thin, portable Internet-enabled client running on a set-top box (such as the one shown in FIG. 3), providing a platform for enhanced TV applications and services. The presently preferred TV navigator runs on the Motorola DCT 2000.

Client Organization

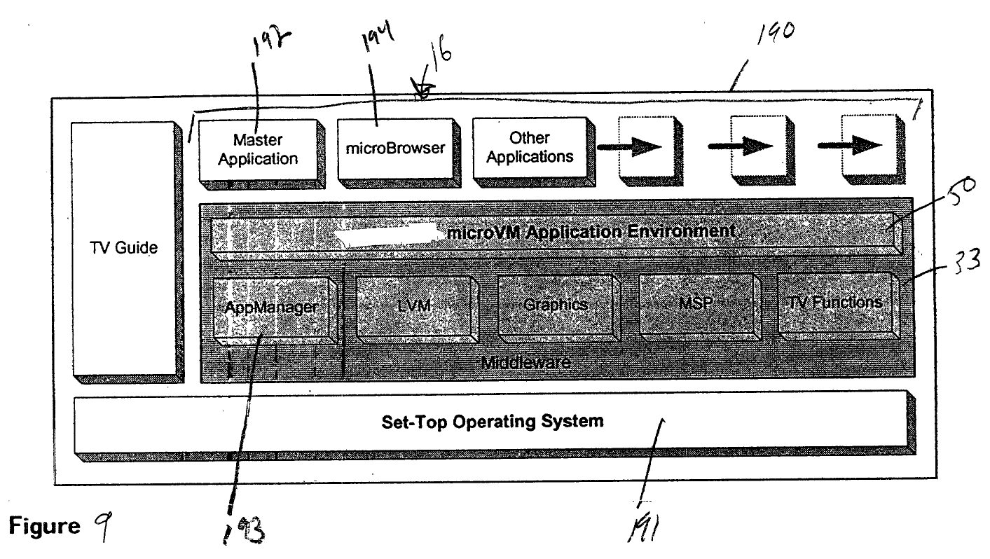

The TV navigator 33 (see FIG. 9) is a middleware environment that shields application developers from the need to write content and software for different set-top environments. All content and applications 190 are written to the middleware environment rather than to a specific set-top platform 191. Applications reside on top of the middleware. The middleware is implemented using the resources available on the specific set-top environment to which it is ported. The DCT 2000 typically has 1.5 MB of RAM, 1.0 MB of Flash, a small amount of NVRAM, and a 25 MHz processor, that is available to applications.

MICROVM APPLICATION ENVIRONMENT (LMAE)

An important component of the client is the microVM application environment (LMAE) 50. It is a Java-based middleware environment that provides TV control, subscriber input control, a core user interface, and a framework for enabling new applications to be developed and loaded without updating the firmware on the set-top box. Network operators can easily create, customize, and enhance these applications to change the look and feel of the Interactive TV.

The LMAE performs the following functions:

Interprets Java applications written to the LMAE APIs

Integrates the applications with the TV broadcast signal (as appropriate) and displays the results on the TV screen

Listens for broadcast content and displays the results on the TV screen

Handles interactions with the network, the user-input devices, and other set-top box components

The client allows the following kinds of applications to be written:

Broadcast electronic programming guides (EPGs)

Broadcast browsing (Web browsing of preselected content over the broadcast channel)

Broadcast-enhanced television applications (eTV, ticker, games)

LMAE Minimum Requirements

The LMAE has been designed to maximize the potential of the resource constrained set-top boxes.

The following list indicates the minimum resource requirement for the set-top box:

1 MB flash and 1.5 MB DRAM and a small amount of NVRAM

16- or 32-bit processor•25 MHz processor (0.5 to 1 MIP available for user tasks)

Graphics capability of at least 352×480 with 4-bit color

Optional: limited, low-bandwidth upstream for store and forward and imprint.

Java Virtual Machine and Virtual Machine

The design philosophy of the virtual machine (LVM) implementation is to maintain compliance with the Java™ Virtual Machine (JVM) specification as much as possible within the memory and other constraints of the underlying device platform. With some exceptions, the herein disclosed VM is compatible with the JVM defined in the Java™ Virtual Machine Specification (Java Series). Applications written for the LVM also run on any standard Java VM.

The presently preferred LVM supports all standard Java virtual machine features except for the following:

Floating point operations. The LMAE does not support the two Java floating point types float and double. Java APIs that require float or double are therefore either not supported or supported in a modified form.

Threads. Threads enable Java applications or applets to perform multiple tasks simultaneously. Due to memory constraints, few set-top boxes or other connected devices provide native thread support; therefore, Java threads are not supported in the LMAE.

Java Native Interface (JNI). The LMAE does not implement the JNI because the invocation of native functionality by the virtual machine is device-dependent and therefore not easily portable. It is also a security advantage to allow only the virtual machine to have access to native functions.

User-defined class loaders. The LMAE does not support user-defined class loaders. It has a built-in class loader that cannot be overridden by other applications.

Reflection. Reflection refers to the ability of Java programs to inspect the number and contents of classes, objects, methods, fields, and other runtime structures inside the virtual machine. This is a very costly feature and is not supported by the LMAE. Consequently, features that rely on reflection—such as RMI, serialization, and profiling—are also not supported.

Opcodes. The majority of the unsupported opcodes are memory-access or math opcodes related to float, double constants, and variables.

Core APIs

Rather than including a proprietary set of Java APIs, the application environment supports a subset of the following standard core Java packages:

java.lang—Provides classes that are fundamental to the design of the Java programming language. The LMAE therefore implements most of the package.

java.applet—All LMAE applications run as subclasses of java.applet.Applet.

java.io—Provides for system input and output through data streams, serialization, and the file system. Only a few classes that are relevant for set-top and device-based applications are included in the LVM.

java.net—Contains classes for implementing networking.

java.util—This package contains the collections framework, event model, date and time facilities, internationalization, and miscellaneous utility classes.

java.awt—Provides classes for creating user interfaces and for painting graphics and images. The lowest level AWT classes contain graphics and event support.

java.awt.event—Provides interfaces and classes for dealing with different events fired by AWT components.

java.awt.image—Provides classes for creating and modifying images. Note that most classes supported in the LMAE contain a subset of the methods defined in the standard Java equivalent. Refer to the microVM API Reference for details on these supported classes.

Extension APIs

The following discussion describes a set of APIs that together form extensions to the standard Java API supported in the LMAE. These APIs are part of the lbrt package.

The lbrt package is divided into the following subpackages:

lbrt.applet—Classes and interfaces related to communication between applets and the application manager. LMAE applets run in an environment unlike most Java applets. Rather than running in the context of a Web browser, LMAE applets run in the context of a set-top box.

lbrt.datapoint—Classes and interfaces related to communication between the client and the Datapoint server.

lbrt.graphics—Classes and interfaces related to television graphics extensions.

lbrt.io—Classes and interfaces related to multicast file systems, stream I/O, and network communications.

lbrt.net—Classes and interfaces to related to communicating with third-party servers.

lbrt.tv—Classes and interfaces related to set-top devices.

lbrt.util—Various utility classes and interfaces, such as timers.

Class Summary for lbrt.util

| | |
|---|---|
| Timer | An abstraction of a timer. |
| TimerEvent | A timer event passed to a TimerListener when a timer goes |
| | off. |

Class Summary for lbrt.applet

| | |
|---|---|
| AppletAdapter | Provides the MasterApplet the means to stop, start, |
| | pause, and resume a TVApplet. |
| AppManager | Provides low-level services for management of |
| | TVApplets over their life cycle. |
| MasterApplet | An application built to control and customize the Liberate |
| | Application Environment. It has privileged access |
| | such that it has the ability to start and stop other |
| | applications. |
| TV Applet | Provides the functionality of an application built to run |
| | within the Liberate Application Environment for TV. |

Interface Summary for lbrt.datapoint

| Interface | Description |
|---|---|
| AttributeEntity | Accesses and manipulates data entities. |
| ServiceEntity | Returns a service object containing all the attributes of |
| | the specified service, including values inherited from |
| | more generic entities. |

Class Summary for lbrt.datapoint

| Class | Description |
|---|---|
| Manager | Initializes the connection to Datapoint, loads attributes and |
| | services from the set-top box, and provides access to the |
| | attributes and services. |
| Service | Implements a Datapoint service; accesses service attributes by |
| | implementing the Entity interface. |
| User | Represents a User with attributes and services; accesses |
| | attributes by implementing the AttributeEntity interface and |
| | services by implementing the ServiceEntity interface. |

Exception Summary for lbrt.datapoint

| Exception | Description |
|---|---|
| DatapointException | Datapoint Exception. |

Master Application

A portion of the middleware platform is dedicated to managing both Java and native applications resident in the set-top box. The master application 192 handles downloading and installing of applets, security, sandboxes, authentication, and other issues. The external interface to the application manager (the interface exposed to applets) is a static class called AppManager 193. Applets use the AppManager interface to call other applications (both native and Java), to register for events, and for other inter-application communication.

Multiple Application Support

The following discussion describes how the LMAE supports Java applets and native applications.

Java Applets

The LMAE supports the loading and running of multiple Java applets simultaneously. Although the LMAE does not support Java threads, the event-driven nature of the environment allows multiple applications to run at once in a cooperative fashion. The LMAE event model allows applications to register event listeners for various categories of events. The occurrence of these events results in the execution of application code.

Native Applications

Native applications, i.e. those applications written to the set-top API rather than the LMAE, may be downloaded to flash by an MSO in the traditional NAC/DAC method and may coexist with the LMAE and LMAE applets. The invention provides a message-based API for native applications to communicate with the LMAE and coordinate resource sharing. This API allows friendly integration between the LMAE and native applications, as well as other third-party interfaces.

The native application message API provides the following categories of services:

Transition control, for coordinating the transition to foreground status between the LMAE and the native application

Memory-usage level negotiation between the LMAE and the native application

Communication between native applications and Java applets

Launching of Java applets by native applications

The general paradigm allows for one application environment at a time (either the LMAE and its applets or a friendly native application) to be the foreground application. The foreground application has exclusive use of set-top resources such as the tuner, the OSD, front panel display, audio, and so on. When not in the foreground state, native applications are limited in the types of activities they can perform. Certain types of activities, such as processing out-of-band data in the background, are still available.

Application Environment

In general, Java applets are downloaded from an external source and run in a sandbox. The sandbox ensures that the applet is run in isolation from other applets and enforces certain security restrictions. Applets downloaded from untrusted sources are given the least access to system resources, including memory, bandwidth, and APIs.

Resource Management

There are four main methods for applications to be downloaded to a set-top device:

Traditional NAC/DAC DLS to flash

MSO controlled out-of-band data carousel

MSO controlled in-band data carousel

Third-party controlled in-band data carousel

Security Using Sandboxes

Each downloaded applet is run within its own self-contained environment, referred to herein as a sandbox. Because the platform allows concurrently running applets, some amount of application level security is necessary to ensure that one applet does not directly affect another applet. Consequently, the LMAE includes a lightweight security manager (part of AppManager) that protects portions of the Java runtime system from inappropriate use. In addition to executing each applet in its own sandbox, the LMAE enforces sandbox restrictions based on the applet's security level.

An applet's security level affects both the resources allocated to it and its access to LMAE APIs.

The sandbox model ensures the following:

Each applet has its own call stack and memory heap.

Only a limited, predefined set of APIs is available to the application. The set of APIs available is determined by the applet's security level.

Applet downloading and class loading is performed by the LMAE class loader. User-defined class loaders are not allowed.

The set of native functions accessible to the virtual machine is closed. This means that applets cannot download any native code that is not part of the LMAE.

The set of system APIs (such as those defined in the previous sections) cannot be overridden by applet code. This ensures that any calls to the standard APIs execute only authorized code.

Memory Management

The LMAE provides memory management services that allow the set-top device's limited memory resources to be shared by multiple applications.

Access to Flash

Access to flash is controlled solely by the MSO's cable network tools. Running applets do not have access to store or read from-flash. Trusted applications may be downloaded to, and run from, flash.

Access to DRAM

Applications can perform dynamic object allocation, but only the LMAE virtual machine is able to directly access memory. An application's security level governs the amount of memory it may use. Untrusted applications are limited to a small amount of memory, restricted applications are allowed more, and trusted applications are limited only by available memory. In addition, if an application with a higher security level requires more memory, an application at a lower security level may be unloaded to free up space.

Access to NVRAM

Applications have access to a certain amount of nonvolatile storage to allow for some degree of persistence of state between invocations. The amount of NVRAM available to an application is governed by its security level: untrusted applications do not have access to NVRAM, restricted applications have access to a small amount of NVRAM, and trusted applications to more. The LMAE itself devotes a small amount of NVRAM for its own internal use.

Hardware (Motorola Set-Top Box)

Motorola's interactive digital consumer terminals (DCTs) offer the latest in audio and video technology. The DCT's 64 and 256 QAM, digital processing technology increases channel capacity over existing cable plants, while providing improved audio and video quality. Motorola's DCT is configured to support real-time reverse path communications, providing a gateway to the information platform's interactive services. To ensure the maximum level of system security, the DCT product line employs the latest in access control technology.

Standard Features

An example of the standard features included with Motorola's DCT 2000 are:

MPEG-2 main level profile video processor

ATSC standard Dolby digital (ac-3) audio processor

ITU standard 64/256 QAM/FEC/enhanced adaptive equalizer

On-board real-time RF return (256 kbps)

High resolution bitmapped graphics display (2/4/8 bit)

6.8 Mb total memory

Messaging capabilities

Renewable security connector (TV passcard)

Clear analog channel processing

54-860 MHz tuner

Des based encryption/DCII access control

Digital diagnostics

2.048 Mbps out of band data receiver

Macrovision copy protection

Wide screen (16×9) video support

4 line vertical blanking interval pass through capability (closed caption)

RF, baseband (video, l/r audio) ports

Audio loop through connectors

Internal application interface port

IR blaster port (high/low power capable)

4 digit, 7 segment LED display

Switched accessory outlet

High/low speed data output ports (27 and 2 Mbps)

Full feature access from front panel

Audio loop through connectors

Optional Features

Motorola and compatible analog descrambling (includes mono audio privacy)

Stereo audio privacy (requires Motorola analog descrambling)

Zenith Z-Tac compatible analog descrambling

BTSC stereo decoder

High power IR blaster tether

Low power IR blaster tether

RF bypass switch or A/B switch

Telephone modem (14.4 Kbps)

Serial data output

S-video output

S/PDIF-Dolby AC-3 output

Advanced Audio and Video

MPEG-2 video decoder: highest picture quality and compatibility with a wide range of programming

Video outputs: RF (Ch 3/4) baseband and high quality component S-video

Wide-screen aspect ratio capability for movie like video display

Dolby Digital audio: access to the digital audio bitstream is provided through an AC-3 S/PDIF interface (optional)

Applications

Several applications have been designed for the information platform environment.

All applications preferably have the following features:

Low memory and processor overhead

Designed to run on various set-top boxes

Fully customizable user interfaces based on HTML and Java

Support for SNMP (simple network management protocol), allowing monitoring and configuration through command, and enabling network operators to track service availability and system performance

Fully integrated with TV navigator and applications

The applications use open standards created by the Internet and broadcast communities. By adopting industry standards, network operators, system integrators and applications developers can leverage their existing technologies, tools, skills, and content.

Master Application

The master application is the first applet to be loaded by the microVM Application Environment (LMAE), and performs the following functions:

Registers for exclusive access to the MENU key, so that selecting the MENU key brings up the master application main menu.

Preloads any important applications such as an EPG or possibly other flash-stored applications.

Manages the resources of the LMAE. It allows only one application to run at a time. The exceptions to this rule are EPGs, which should always be left running, and the master application itself. These two applications, when available, are always left running. All other applications are loaded and unloaded on demand.

Provides tiering capabilities to allow the MSOs to establish the services being provided to a particular set-top box. Some of the settings fields (such as EPG Region, Country Code, Currency1, and Currency2) can be modified on a per set-top box basis, and this can be used to define tiers of service such as “basic service” or “basic service plus games.”

Supports the display of full-screen advertisements during an in-band Mediacast channel load. The images to be displayed are taken from the list in the configuration file, and if no ads are found, it displays the default Powered by XYZ screen.

Provides statistical information.

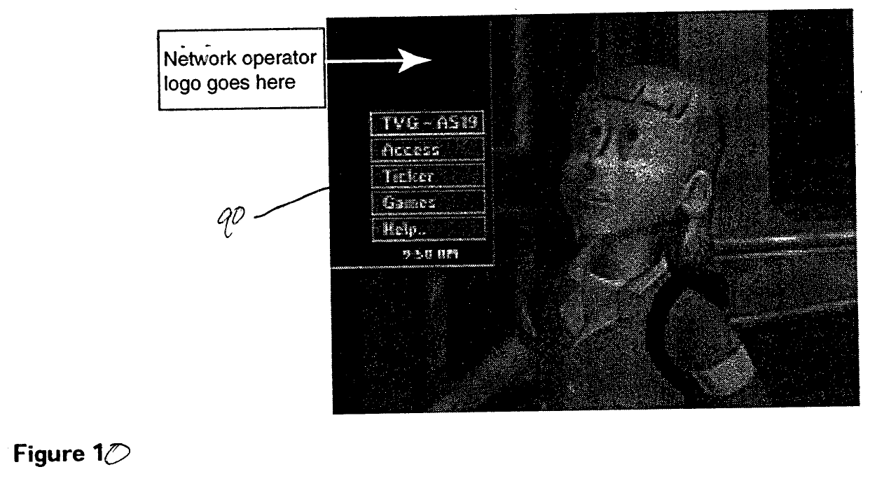

FIG. 10 shows the master application Home Menu 90 on top of a television broadcast.

Microbrowser

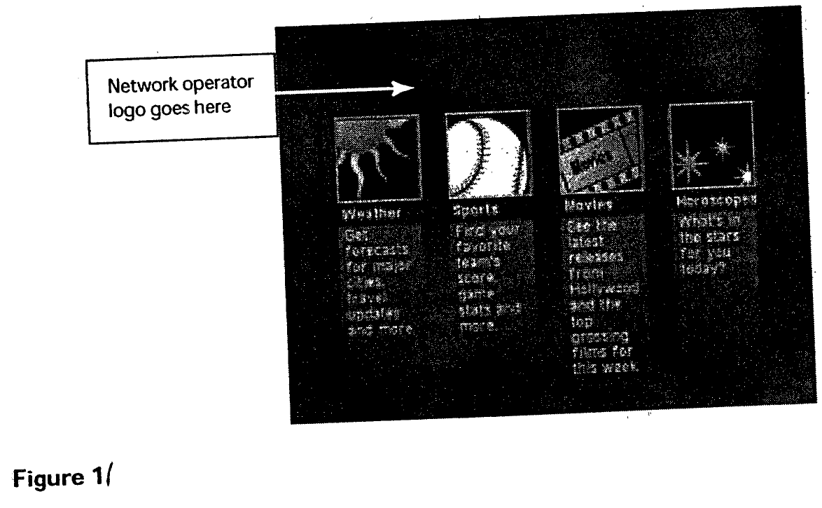

The microbrowser 194 (FIG. 9) is an LMAE application that can be used to view broadcast managed content that has been authored in HTML. The server software handles retrieving and transcoding HTML content on a set schedule. This transcoded content is then inserted into the multicast file system for use by the microbrowser. When activated, the microbrowser reads and displays the home URL. These URLs can either be specified in the microbrowser's configuration file, or in an eTV trigger. The user can then navigate the content in much the same manner as regular interactive HTML content. Selecting some links cause the microbrowser to read and display another page of managed content, while other links start an application such as a game. When users exit an application, they are returned to the Web page from which the application was initiated. Because much of the content can be pre-cached, managed content can avoid the long latencies associated with the Internet and produce response times of typically less than one second. FIG. 11 shows a typical microbrowser screen.

TV Ticker

The TV ticker is a client/server application that delivers dynamic, user-controlled news and information to TV Navigator-enabled set-top boxes.

TV ticker provides the following features:

Dynamic, user-controlled news headlines and full stories delivered directly to the TV

Two User Interface (UI) options:

ticker as a minimal overlay on full-screen TV

Full-screen ticker

News categories based on subjects of interest, filtered on the client to eliminate scalability issues

Customizable UI for operator branding with advertising-ready design

Automatic import and export of ticker data (the operator simply configures URLs for the data feeds, categories, and fetch intervals)

Automatic parsing of ticker feed into headlines and full stories

Multiple feeds for the operator to choose from, including national news, business, sports, and entertainment

Pre-integration with the Mediacast server for broadcast of ticker headline and full story data

SNMP support

Importing Data into the TV ticker server

TV ticker can be configured to import news stories over multiple categories on regular intervals. For example, TV ticker can be instructed to import the top 10 stories of a category every 15 minutes. Multiple categories might include national news, sports, financial news, and entertainment. The TV ticker server makes HTTP requests to a content feed server to fetch top stories. The categories and number of stories to fetch are encoded in the URL, as specified by the content feed supplier. TV ticker is configured with different URLs for each feed that it is required to import. The syntax or semantics of these URLs is dictated by the content feed supplier. TV ticker reads only the import format of the data that is returned by the content feed server.

Content Feed URL Syntax

TV ticker is configured to use a URL for each category of news to be fetched. The syntax of the URL is determined by the content provider. It should, at a minimum, include the category and the number of stories to fetch. For instance, a URL to fetch the top 10 sports stories might be encoded as: http://www.content-provider.com/import?category=sports&numStories=10

There are many ways to encode information in a URL. Because the content feed server is the only piece of code interpreting the URL, it makes sense that the content feed provider define their own URL syntax.

Exporting Data to TV Navigator

TV ticker delivers content to the client using broadcast delivery through Mediacast. In this method, the Mediacast server retrieves data from the ticker server and inserts it into the broadcast stream. Mediacast uses HTTP to get the news headlines and news stories, which are supplied by the ticker server in CDF format. For full stories, the ticker-supplied CDF file refers to Java Server Pages (JSP) used to format the story. Mediacast then fetches the JSP from the ticker server as it prepares the content items for carouseling The ticker server returns HTML files for each JSP request. Two Mediacast carousels must be created and configured for delivery of ticker data.

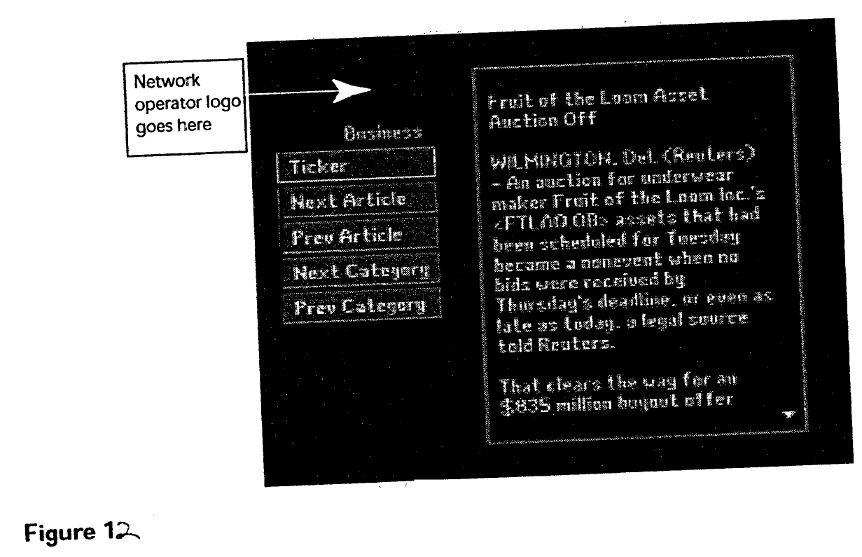

FIG. 12 shows an example of a full-screen TV ticker display.

Games

The following discussion briefly describes some of the games that may be provided with the information platform.

Solitaire

This game requires the player to use all the cards in the deck to create four stacks of cards from the same suite, in ascending order. This stack is to be created at the top right of the screen. The columns of cards are manipulated to access the appropriate card to build the same-suit stack.

Grabber

The object of this game is to clear the screen of all the colored balls as they drop from the top of the frame, and before they crush the spring. There are nine levels of play.

Lagoon

In this game, the diver must shoot the fish before the fish can touch the diver. The diver must also avoid being shot by the jellyfish.

HoneyHunt

In this game, the player must uncover all the hidden tiles of honey, and avoid all the bees. The game board consists of tiles that are covering up the image of either a bee or honey. A numbered tile indicates the number of its edges touching bees' tiles.

Spades

Spades is a team game with 4 players, where the players sitting opposite each other play as a team. The partners in a team work together to earn points through a series of successful bids. The first team to reach 500 points wins. This game offers two modes: standard and suicide.

Golf

This game is similar to a real golf game. It can be played by one to four players. The players use the remote control to choose and swing the golf club, and to view game information.

Vexed The objective of Vexed is to clear the grid of all the symbol blocks by moving the same-symbol blocks next to each other. Two or more same-symbol blocks destroy each other as soon as they make contact.

Memory

The objective of this game is to uncover matching pairs of hidden tiles.

ClickOut

This game consists of a board made of three to five different colored pattern blocks. The object of the game is to clear the board of all the blocks. To remove block users have to find a sequence of two or more blocks that are connected either horizontally or vertically; diagonals do not count. As the user removes blocks from the board, the remaining blocks drop down and to the left until there are no more blocks to remove.

Blackjack

As with the card game, this game requires the player to beat the dealer in obtaining a hand closest to 21, without going over.

Quiz

This game requires the player to correctly answer trivia questions from three levels of play, and accumulate enough points to win the level.

Picnic Antics In this game, tiles, each showing an ant, are placed on a 9×9 grid three at a time. A player must remove as many as possible from the grid by sliding them into rows of five or more. Each row must consist of only like ants (ants of the same color and design), which may go in a horizontal, vertical, or diagonal direction.

Breakout

This game is based on DX-Ball (also known as Brick Out, Block Out). The game consists of a number of “bricks” set in layered rows, a paddle, and a ball. The game objective is to hit all of the bricks using the ball, and bounce off the paddle.

Cannon Ball

In this game, there are six different colors of cannon balls that you can fire, burst, and drop. The objective is to eliminate all the cannon balls from the screen by combining three or more like-color balls.

Snake

This game consists of a snake, mice, and obstacles. The object of the game is for the snake to continue swallowing the mice, while avoiding crossing its own tail or crashing into obstacles.

Enhanced Television (ETV)

The purpose of eTV (enhanced television) is to synchronize the presentation of additional content with a broadcast program. The content can be an application developed on the LMAE (such as a game), or it could be HTML content that is broadcast as part of the broadcast managed content. This feature offers many benefits in terms of program enhancements, or focused advertisements. As an example, consider a cooking show on which an eTV trigger (an icon) appears, indicating to the viewer that additional information is available. The viewer selects the icon and is presented with list of ingredients for a recipe that is being demonstrated during the show.

Data Carousel Update Server (DCU)

The DCU provides a server process on the MMS to support remote Web client uploading of applets, image, or data files to the data carousel. This is where the enhanced TV triggers (eTV triggers) can be created, deleted or modified. The interface to the DCU server is accessed using any HTML 4.0 and JavaScript-enabled browser (Netscape 4.72 or higher). The servers must be set up to have access to the DCU, and the browser must be pointing to the server on which the service is running.

Development Environments

The TV navigator is a middleware environment that shields application developers from the need to write content and software for different set-top environments. All content and applications are written to the middleware environment rather than to a specific set-top platform. The middleware is implemented using the resources available on the specific set-top environment to which it is ported. An important component of the client is the microVM application environment (LMAE), a Java-based middleware environment that provides TV control, subscriber input control, a core user interface, and a framework for enabling new applications to be loaded without updating the firmware on the set-top device. Network operators can easily create, customize, and enhance these applications to change the look and feel of the Interactive TV subscriber experience.

Applications intended for the TV navigator Information client are typically developed in one of two environments:

On a PC, with no access to the set-top box itself

STB (set-top box) or DCT environment

In the PC environment, developers do their initial development work on a PC, and then verify that the programs operate properly in the actual STB environment. In an STB environment, the developer has direct access to the broadcast hardware that is found at a typical MSO (multiple system operator), and is thus better able to design and test applications directly in a broadcast environment while they are developing.

TV Producer Information

TV producer is a content developer's kit containing information, tools, and examples to help applications and content developers create Interactive TV content. TV producer is intended for developers with previous Java experience. It contains the following components:

A set of tools:

Class File Parser. Disassembles a class file and outputs a summary of its contents.

Static API Checker. Compares the APIs in a compiled Java application to a list of microVM APIs.

Static Byte Code Verifier. Checks for valid microVM bytecode in a compiled application.

JAR Optimizer. Optimizes access to a .jar file.

Vector Quantization Utility. Converts PC bitmap images to the lightweight VQ (vector quantize) file format.

Content Development for Microbrowser

Web content, such as HTML, is typically designed for display on a high-resolution computer monitor with access to millions of colors. The display quality of a television is considerably poorer than a monitor. The microbrowser uses the standard 16-color palette for drawing foreground text and graphics. Any color references in the source HTML of the content is mapped to one of the colors in the system palette, which roughly approximates the 16 standard HTML colors.

The invention also comprises a layout tool for previewing the content. The layout tool enables content developers to preview their content in the information platform environment without access to a head-end server system, cable network, or set-top device. The layout tool is a CGI process hosted on a standalone content processor that, when given the URL of a Web page, returns an HTML page embedding the rendered preview of that page (as a JPEG image) as it would look on TV navigator.

Customization Features

The invention provides MSOs with the ability to customize the master application, and to a limited extent the TV ticker. Some of the customizable features of the master application include the logo, graphics, colors, positioning, button labels, button actions and menus.

Background Graphics

The invention also enables content developers to include aesthetically pleasing JPEG images into the background of an application. The I-frame can be a standard 24-bit JPEG file, which is stored on the application server and sent to the transcoder. The transcoder converts this JPEG file into an MPEG I-frame, allowing the set-top box to render it. The MPEG I-frame is sent via an inband channel to the client, and the client then overlays the applet on the I-frame image. This technique enables content developers to off load memory-intensive images to the server. The background graphics are always in 24-bit color, and 704×480 resolution, regardless of the graphics mode of the set-top box. This means that all background graphics for applications, as well as the microbrowser content, remains the same regardless of the set-top box's graphics resolution.

Examples of background graphics include the I-frame advertisements displayed by the MasterApplet, background graphics for games, and the background managed content displayed by the microbrowser.

Foreground Graphics

Foreground graphics refers to text, simple graphics, and bitmaps that are drawn on top of the underlying broadcast video or MPEG frames.

Examples of foreground graphics include the MasterApplet main menu panel, all the TV ticker graphics, and foreground-managed content text (rendered by the microbrowser). When integrated with an EPG, the middleware is configured to run in low color (4-bit graphics), low resolution (352×480) foreground graphics mode. Developers can use either the standard 16-color palette, or their own customized 16-color palette for developing applications.

Network and Equipment Requirements

The general specifications in this discussion outline the information platform's typical or standard hardware, telecommunications, and network requirements. This discussion also introduces typical system installations for various service and application mixes.

The information platform is flexible, and a number of different configurations are possible. Arriving at a final estimate of hardware needs depends on the following:

The final hardware configuration is a function of the mix of services and applications required.

Network demand is determined by making assumptions about the types of information the users access.

Overall system requirements are determined by combining the network demands with the capacity of each component.

The information platform architecture illustrated in FIG. 2 includes the following features:

Fault tolerance—three levels of fault tolerance are provided, namely critical hardware, subsystem redundancy, and software fault tolerance.

Scalable architecture whereby components may be added depending on the service offering.

Multiple caches to increase performance and service capacity.

Broadcast System

The following bandwidths are required for a typical broadcast configuration.

Out-of-Band Bandwidth Requirement

The total available bandwidth for a typical service mix is 80 kbps.

The following bandwidth is recommended for the various components:

Directory structure and system configuration—The bandwidth required depends on the services provided, but a typical requirement is 25 kbps.

TV ticker—The bandwidth used depends on the number of stories and categories. For example, 10 stories, 6 categories, and 60 headlines requires 20 kbps.

Games—Applications do not typically use out-of-band, therefore no bandwidth is required.

ATVEF triggers—This requires 10 kbps of bandwidth.

In-Band Bandwidth Requirement

The total bandwidth requirement for a typical service mix is 8300 kbps, and consists of the following:

Microbrowser—The total requirement depends on the depth, type, and range of content, but it generally requires 5 mbps for 250 pages of walled garden, and 1 mbps for dynamic additions.

TV ticker—The bandwidth used is dependent on the number of stories and categories. For example, 10 stories, 6 categories, and 60 headlines requires 720 kbps.

Other applications—This depends on the number and size of the application and the application's load-time. For example, twenty 65 KB applications, with 10 seconds load-time would require 1.2 mbps.

Miscellaneous—Directory structures and system overhead require 500 kbps.

Typical Configuration

The typical broadcast configuration consists of the following:

MediaCast/MMS—with SUN 220R (equipped with the Liberate LMC multiplex card)

TV ticker and imprint—Sun Netra T1s

Content processors/RACS—Dell 2550s

Equipment Requirements

The information platform uses of Motorola's standard interactive configuration. Equipment requirements are summarized here.

QAM Modulator/RF Upconverter

The information platform server output is converted to a 64 or 256 QAM RF modulated signal by one of the following equipment configurations:

Scientific Atlanta SA D9476

Motorola MPS or IRT in combination with an 8C* upconverter.

OM1000 Out-of-Band Modulator

The out-of-band modulator provides the out-of-band channel to the OM1000. Currently one OM1000 is recommended for each NC1500 used in a broadcast-only system.

NC1500 Network Controller

The NC1500 is a sophisticated router that manages the upstream traffic. In addition to its routing function, the NC1500 also manages IP assignments, manages the ALOHA protocol, and provides a status and monitoring console for the upstream traffic. Each NC1500 can support 25,000 DCTs (125,000 homes passed), 10 RPDs, and 10 OM1000s. Note that the OM 100 and the NC 1500 are only necessary in a broadcast-only system if you are collecting statistics and need a return path.

RPDx000 (Reverse Path Demodulators)

The RPDs contain the demodulators that process the QPSK modulated signal from the DCTs. In the recommended configuration, the demodulators are arranged in a fault-tolerant frequency diversity pair. Each RPD can accommodate six DM1000 demodulators, and therefore can service three IRNs or 12,000 homes passed.

HMS/DAC6000

The HMS/DAC6000 (head end management system/digital addressable controller), manages configuration of and loads software for DCT set-top boxes.

IRT (Integrated Receiver Transcoder)

The IRT receives and transcodes satellite signals.

Telecommunication Requirements

The following telecommunication components are part of a information platform configuration.

Analog Telephone

The application server is connected to a dedicated analog telephone line. The analog telephone line is used as an emergency remote access connections in the event of a problem with the Internet access.

Internet Access

Internet access requires a cable modem or equivalent (128 Kb/s) for optimum performance.

Cable TV Distribution System

The head-end components are connected to a CATV distribution system to allow multiple set-top boxes to be connected.

Power Requirements

Each rack requires two dedicated 120 v-15A power circuits with the following specifications:

AV Voltage Rating—120 VAC

Current—20 Amp

Frequency Range—47-63 Hz Each power circuit should be terminated with a 15 amp twist lock receptacle, within 10 feet of the rack installation location.

information platform/Motorola Equipment IP Addressing

The information platform requires N+1 connections to the Motorola OAM&P and Motorola application networks, where N is the number of the information platform's Application Servers.

OAM&P Network

This network uses a subnet mask of 255.255.0.0 or 200.200.0.0, depending on the Motorola requirement. It is used for all of the Motorola equipment. The recommended cable color for this network is green.

DAC Requirements

The TV navigator application OS and DAC OS requirements are as follows:

TV Navigator Application/OS

TV navigator application version:

Liberate information platform 3.0.30 client release

OS platform version: 7.10 or later.

DAC OS

DAC Version: 2.45 or later.

Space Requirements

The space requirements listed here are for a typical installation. The final requirement depends on the size of the system and the services offered.

Application Servers

In a typical EPG installation, the application server equipment is housed in a single rack consisting of:

2 information platform Application Servers

1 information platform Remote Access Control Server

1 keyboard and monitor

2 IM1000 (640AM modulator) or equivalent

Dual power strip

If the service includes advanced interactive applications (with or without the EPG), the following equipment is required and may necessitate a second rack:

2 information platform content processors

2 Ethernet switches

Internet interface/router (cable modem or T1 connection)

2 mass storage systems (SCSI drives in Raid 5 configuration)

Dual power strip

For each information platform application server, an up converter (½ of C6U) is required. It is recommended that the up converters be installed in the rack with the other RF equipment.

Glossary

CPML Information platform markup language

DCCG The DigiCable control channel generator. This is a Motorola component needed by the set-top box to get a channel map.

DCS Data carousel server; also referred to as MediaCast

DCT Digital consumer terminal, model 2000 from General Instruments. This is a particular variety of set-top box.

DCU Data carousel update server.

DRAM Dynamic random access memory

DSMCC A session-management protocol

DSR Downstream router

eTV Enhanced television

J2ME Java2 micro edition. This is Sun's subset of Java that is designed for consumer electronic devices such as television set-top boxes.

JSDK Java software development kit. This is a collection of tools used to write Java programs. These tools typically include a compiler and a virtual machine interpreter.

LMAE microVM application environment. This is a VM-and-API set designed for consumer electronic devices, such as television set-top boxes. LMAE is based on J2ME for connections, limited device configuration.

LMC MPEG card

LSCP Lightweight stream control protocol

MMS Multimedia streamer

MMS_OM1000 An out-of-band server

MPEG Motion picture experts group

MSO Multiple system operator

MSP The Mediacast signaling protocol. A system for delivering data and multimedia resources to the STB using one-way (downstream) communications.

OM1000 Out-of-band modulator

OMI Operator management interface

OSD On-screen digitizer

QAM Quadrature amplitude modulation

SRM Session resource manager

STB Set-top box

TVN-C An informal name for the TV navigator client

VM Virtual machine. It is an interpreter for a virtual machine language.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An apparatus for enhancing set-top box functionality, comprising:
an interpreted language application environment that comprises TV control, subscriber input control, a core user interface, and a framework for enabling new applications to be developed for, and loaded onto, said set-top box without updating firmware on said set-top box;
wherein all content and applications used to enhance said set-top box functionality are written to said application environment rather than to a specific set-top platform; and
wherein said application environment is implemented using resources available on a specific set-top box to which it is ported; and
one or more applications which reside on top of said application environment and which add functionality to said set-top box.

2. The apparatus of claim 1, wherein said one or more applications comprise any of TV ticker, one or more games, a microbrowser, a store and forward application and an imprint server for gathering subscriber interactions and statistics.

3. The apparatus of claim 1, wherein said application environment performs any of the following functions:
interpreting Java applications written to application environment APIs;
integrating said applications with a TV broadcast signal, as appropriate, and displaying results on a TV screen;
listening for broadcast content and displaying results on said TV screen; and
handling interactions with a network, user-input devices, and other set-top box components.

4. The apparatus of claim 1, wherein said application environment supports any of the following applications:
broadcast electronic programming guides (EPGs);
broadcast browsing; and
broadcast-enhanced television applications.

5. The apparatus of claim 4, wherein said application environment comprises a built-in class loader that cannot be overridden by other applications.

6. The apparatus of claim 1, wherein said application environment comprises a subset of the following standard core Java packages:
java.lang, which provides classes that are fundamental to the design of the Java programming language;
java.applet, wherein all applications run as subclasses of java.applet.Applet;
java.io, which provides for system input and output through data streams, serialization, and a file system;
java.net, which contains classes for implementing networking;
java.util, which contains a collections framework, event model, date and time facilities, internationalization, and miscellaneous utility classes;
java.awt, which provides classes for creating user interfaces and for painting graphics and images, wherein a lowest level AWT classes contain graphics and event support;
java.awt.event, which provides interfaces and classes for processing different events fired by AWT components; and
java.awt.image, which provides classes for creating and modifying images.

7. The apparatus of claim 1, wherein said application environment comprises:
a set of APIs that together form extensions to a standard Java API supported in said application environment.

8. The apparatus of claim 1, wherein said set of APIs comprises any of:
an API which comprises classes and interfaces related to communication between applets and an application manager, wherein said applets run in the context of said set-top box;
an API which comprises classes and interfaces related to communication between a client and a server;
an API which comprises classes and interfaces related to television graphics extensions;
an API which comprises classes and interfaces related to multicast file systems, stream I/O, and network communications;
an API which comprises classes and interfaces to related to communicating with third-party servers;
an API which comprises classes and interfaces related to set-top devices; and
an API which comprise various utility classes and interfaces.

9. The apparatus of claim 1, wherein a portion of said application environment is dedicated to managing both Java and native applications resident in said set-top box.

10. The apparatus of claim 1, said application environment further comprising:
a master application for handling downloading and installing of applets, security, sandboxes, authentication, and other issues.

11. The apparatus of claim 1, said application environment further comprising:
an external interface to an application manager;
wherein applets use said external interface to call other applications, both native and Java, to register for events, and for other inter-application communications.

12. The apparatus of claim 1, said application environment further comprising:
an event-driven model that supports loading and running of multiple Java applets simultaneously in a cooperative fashion;
wherein said event model allows applications to register event listeners for various categories of events; and
wherein the occurrence of said events results in execution of application code.

13. The apparatus of claim 1, wherein native applications written to said set-top API may be downloaded to memory in a conventional method and may coexist with application environment applets.

14. The apparatus of claim 1, further comprising:
a message-based API with which one or more native applications communicate with said application environment and which coordinates resource sharing to allow integration between said application environment and native applications.

15. The apparatus of claim 14, wherein said message-based API provides any of the following categories of services:
transition control for coordinating transition to foreground status between said application environment and said one or more native applications;
memory-usage level negotiation between said application environment and said one or more native applications;
communication between said one or more native applications and Java applets; and
launching of said Java applets by said one or more native applications.

16. The apparatus of claim 14, wherein either of said application environment and associated applets or said one or more native applications is a foreground application that has exclusive use of said set-top box resources;
wherein, when not in the foreground state, said one or more native applications are limited in types of activities they can perform.

17. A method for enhancing set-top box functionality, comprising the steps of:
downloading one or more Java applets from an external source to a Interpreted language application environment that comprises TV control, subscriber input control, a core user interface, and a framework for enabling new applications to be developed for, and loaded onto, said set-top box without updating firmware on said set-top box;
wherein all content and applications used to enhance said set-top box functionality are written to said application environment rather than to a specific set-top platform; and
wherein said application environment is implemented using resources available on a specific set-top box to which it is ported; and
providing one or more applications which reside on top of said application environment and which add functionality to said set-top box.

18. The method of claim 17, further comprising the steps of:
providing a mechanism for ensuring that said one or more Java applets are run in isolation from other applets within its own self-contained environment; and
enforcing security restrictions, wherein applets downloaded from untrusted sources are given least access to system resources.

19. The method of claim 17, where said Java applets are downloaded in any of the following manners:
traditional NAC/DAC DLS to flash;
MSO controlled out-of-band data carousel;
MSO controlled in-band data carousel; and
third-party controlled in-band data carousel.

20. The method of claim 18, wherein said mechanism for ensuring that said one or more Java applets are run in isolation from other applets ensures any of the following:
each applet has its own call stack and memory heap;
only a limited, predefined set of APIs is available to an application; wherein a set of APIs available is determined by an applet's security level;
applet downloading and class loading is performed by a class loader; wherein user-defined class loaders are not allowed;
a set of native functions accessible to said application environment is closed; wherein said applets cannot download any native code that is not part of said application environment; and
said set of system APIs cannot be overridden by applet code; wherein any calls to standard APIs execute only authorized code.

21. The method of claim 17, further comprising the step of:
providing memory management services that allow limited memory resources of a set-top box to be shared by multiple applications.

22. The method of claim 17, wherein said one or more applications have any of the following features:
low memory and processor overhead;
able to run on various set-top boxes;
fully customizable user interfaces based on HTML and Java; and
support for SNMP (simple network management protocol), allowing monitoring and configuration through command, and enabling network operators to track service availability and system performance.

23. The method of claim 17, further comprising the step of:
providing a master application, which comprises a first applet to be loaded by said application environment, and which performs any of the following functions:
registers for exclusive access to a MENU key, so that selecting a MENU key brings up a master application main menu;
preloads any important applications;
manages resources of said application environment;
provides tiering capabilities to allow MSOs to establish services being provided to a particular set-top box;
supports display of full-screen advertisements during an in-band channel load; and
provides statistical information.

24. The method of claim 18, further comprising the step of;
providing a master application, which comprises a first applet to be loaded by said application environment, and which performs any of the following functions:
registers for exclusive access to a launch button and that actuating the launch button results in display of a master application main menu;
preloads any important applications;
manages resources of said application environment;
provides tiering capabilities to allow MSOs to establish services being provided to a particular set-top box;
supports display of full-screen advertisements during an in-band channel load; and
provides statistical information.

25. The method of claim 24, further comprising the step of:
providing a server process to support remote client uploading of any of applets, images, or data files to a data carousel to create, delete, or modify enhanced TV triggers.

26. An apparatus for enhancing set-top box functionality, comprising:
a middleware environment;
wherein content and applications are written to said middleware environment rather than to a specific set-top platform;
wherein said middleware environment is implemented using resources available on a specific set-top environment to which it is ported; and
a framework for enabling new applications to be loaded to said set-top box without updating said firmware on said set-top box; and
a TV producer module which contains any of the following components:
a class file parser which disassembles a class file and outputs a summary of its contents;
a static API checker, which compares APIs in a compiled Java application to a list of middleware environment APIs;
a static byte code verifier which checks for valid middleware environment bytecode in a compiled application;
a JAR optimizer which optimizes access to a jar file;
a vector quantization utility which converts PC bitmap images to a lightweight VQ (vector quantize) file format; and
a layout tool which enables content developers to preview content in said middleware environment without access to a head-end server system, cable network, or a set-top device.
